(19) United States
(12) Patent Application Publication
(10) Pub. No.: US 2022/0140550 A1
(43) Pub. Date: May 5, 2022

(54) FLEXIBLE FLAT CABLE AND STACK-TYPE BUSBAR INCLUDING THE SAME

(71) Applicant: JINYOUNG GLOBAL Co., Ltd., Seongju-gun (KR)

(72) Inventor: Kyongdo KIM, Suwon-si (KR)

(73) Assignee: JINYOUNG GLOBAL Co., Ltd., Seongju-gun (KR)

(21) Appl. No.: 17/086,694

(22) Filed: Nov. 2, 2020

(51) Int. Cl. H01R 25/14; H01R 43/20; H02G 5/00; H01B 7/04; H01B 13/012; H01B 7/08

(52) U.S. Cl. CPC H01R 25/14; H01R 43/20; H01B 7/0838; H01B 7/04; H01B 13/01254; H02G 5/005

(57) ABSTRACT

A stack-type busbar includes one or more flexible flat cables (FFCs), each having at least one opening where the busbar is bent.

### FIELD

Embodiments of the present disclosure are applicable to a technical field related to a busbar, and more particularly, relate to a FFC (flexible flat cable) and a stack-type busbar including the same.

### BACKGROUND

Recently, as demand for eco-friendly vehicles and electric vehicles increases, the capacity of batteries is increasing in order to maintain the vehicle for a long time. As the battery capacity increases, a thickness of a cable for delivering power should increase as well. In this case, there is a problem that fuel economy of the vehicle is reduced.

In order to solve this problem, interest in FFC (flexible flat cable) which is flexible and flat that is folded into various shapes and has no limit in terms of selection of the number of strands of conductor wires, and is able to be installed in a small space is rising, compared to a wire harness.

FFC is a cable having a built-in conductor layer composed of a plurality of conductor wires, and acts as a data communication line or a power line that contributes to lighter weight and slimming of various electronic products. FFC is used in various industrial fields including automobiles, medical devices, semiconductor equipment, and computers.

Recently, with spread of next-generation vehicles such as hybrid vehicles or electric vehicles, demand for automotive electronic devices and electric devices that cope with high voltage and high current is increasing. A busbar is a component to connect power to each part of the next-generation automobile.

A busbar functions as a wiring component that is electrically connected to electronic components, or electronic devices such as a motor, an inverter, or a generator. In general, a large current flows through the busbar of a vehicle. However, there are cases in which electronic components, electric devices, or electronic devices allow AC current as well as direct current DC to flow through the busbar.

### SUMMARY

However, when the flexible flat cable (FFC) is designed without considering a cross-sectional area of a metal structure and a type of a film included in the FFC, heat dissipation effect may be lowered, and a weight of the FFC may be increased. Further, when the FFC is manufactured without taking into account a type of a metal conductor included in the metal structure, a cost of the FFC may increase.

Further, due to a limited space in which the busbar including at least one FFC is disposed, a portion of the busbar must be bent such that the busbar is connected to an electronic device. However, in this case, the connection may be difficult due to a thickness and rigidity of the busbar itself.

Therefore, in manufacturing a busbar including one or more FFCs, FFC having increased heat dissipation effect and having a reduced cost, and a stack type busbar including such FFCs are required.

Further, an improved busbar structure so that a predefined region may be easily bent is required.

A first aspect of the present disclosure provides a stack-type busbar including a first layer, a second layer, and a third layer, wherein the first layer is disposed on the second layer, and the second layer is disposed on the third layer, wherein each of the first layer and the third layer includes: two insulating coating layers vertically spaced from each other; a plurality of metal structures disposed between the two insulating coating layers and arranged horizontally and spaced apart from by a predetermined spacing; and an adhesive filled between the two insulating coating layers to fix the plurality of metal structures while surrounding the plurality of metal structures, wherein the second layer has a thickness greater than or equal to a predefined value for heat dissipation of the first layer and the third layer, wherein a spacing between adjacent metal structures included in the first layer is greater than or equal to a spacing between adjacent metal structures included in the third layer.

In one implementation of the stack-type busbar of the first aspect, each of the plurality of metal structures includes one of iron (Fe), sludge metal, and aluminum (Al).

In one implementation of the stack-type busbar of the first aspect, each of the two insulating coating layers has thermal emissivity higher than or equal to thermal emissivity of the adhesive, wherein the adhesive has thermal emissivity higher than or equal to thermal emissivity of each of the plurality of metal structures.

In one implementation of the stack-type busbar of the first aspect, each of the two insulating coating layers includes a polycyclohexane dimethylene terephthalate (PCT) film.

In one implementation of the stack-type busbar of the first aspect, the adhesive includes polyester.

In one implementation of the stack-type busbar of the first aspect, each of the plurality of metal structures has a thickness of 0.2 mm to 0.5 mm and a width of 0.05 mm to 0.15 mm.

In one implementation of the stack-type busbar of the first aspect, each of the first and third layers is formed using: a first lamination process in which heat of a temperature within a range of 100° C. to 110° C. and a pressure within a range of 1 kgf/cm² to 3 kgf/cm² are applied to the two insulating coating layers; and then a second lamination process immediately after the first lamination process in which heat of a temperature within a range of 140° C. to 160° C. and a pressure within a range of 90 kgf/cm² to 110 kgf/cm² are applied to the two insulating coating layers.

In one implementation of the stack-type busbar of the first aspect, the busbar further comprises a reinforcing film formed on an outer face of each of the two insulating coating layers, and located opposite to the metal structures, wherein the reinforcing film is thermally compressed and bonded to each of the two insulating coating layers using a third lamination process in which a temperature in a range of 110° C. to 130° C. and a pressure in a range of 1 kgf/cm² to 3 kgf/cm² are applied to the reinforcing film and each of the two insulating coating layers.

In one implementation of the stack-type busbar of the first aspect, each of metal structures at both ends of an array of the metal structures in a horizontal direction in each of the first layer and the third layer extends outwardly of one of the two insulating coating layers in a horizontal direction.

In one implementation of the stack-type busbar of the first aspect, the busbar further comprises a hollow tube disposed in the second layer, wherein a fluid flows in the hollow tube.

In one implementation of the stack-type busbar of the first aspect, the stack-type busbar further comprises a bridge disposed in the second layer and configured to maintain a spacing between the first layer and the third layer to be equal to or greater than a predefined spacing.

In one implementation of the stack-type busbar of the first aspect, the stack-type bus bar further comprises a connector connected to each of metal structures at both ends of an array of the metal structures in a horizontal direction.

A second aspect of the present disclosure provides a stack-type busbar comprising: a vertical stack of a plurality of flexible flat cables (FFCs); at least one hollow tube sandwiched between vertically adjacent two FFCs of the plurality of FFCs, wherein a fluid flows in the at least one hollow tube to dissipate heat discharged from the plurality of FFCs; and a connector connected to each of both ends of each of the plurality of FFCs, wherein each flexible flat cable (FFC) includes: two insulating coating layers vertically spaced from each other, wherein each of the two insulating coating layers includes a polycyclohexane dimethylene terephthalate (PCT) film; a plurality of metal structures disposed between the two insulating coating layers and arranged horizontally and spaced apart from by a predetermined spacing; and an adhesive filled between the two insulating coating layers to fix the plurality of metal structures while surrounding the plurality of metal structures, wherein each of the plurality of metal structures includes one of iron (Fe), sludge metal, and aluminum (Al).

In one implementation of the stack-type busbar of the second aspect, each of the at least one hollow tube has a polygonal shape.

In one implementation of the stack-type busbar of the second aspect, each of the at least one hollow tube has a circular shape.

In one implementation of the stack-type busbar of the second aspect, each of the at least one hollow tube is made of an insulators or a conductor.

A third aspect of the present disclosure provides a stack-type busbar comprising: a vertical stack of a plurality of flexible flat cables (FFCs); at least one bridge sandwiched between vertically adjacent two FFCs of the plurality of FFCs; and a connector connected to each of both ends of each of the plurality of FFCs, wherein each flexible flat cable (FFC) includes: two insulating coating layers vertically spaced from each other, wherein each of the two insulating coating layers includes a polycyclohexane dimethylene terephthalate (PCT) film; a plurality of metal structures disposed between the two insulating coating layers and arranged horizontally and spaced apart from by a predetermined spacing; and an adhesive filled between the two insulating coating layers to fix the plurality of metal structures while surrounding the plurality of metal structures, wherein each of the plurality of metal structures includes one of iron (Fe), sludge metal, and aluminum (Al), wherein the at least one bridge maintains a spacing between the vertically adjacent two FFCs to be equal to or greater than a predefined spacing.

In one implementation of the stack-type busbar of the third aspect, the bridge includes one or more bent portions.

In one implementation of the stack-type busbar of the third aspect, the bridge is made of a conductor.

In one implementation of the stack-type busbar of the third aspect, the bridge is made of an insulator.

A fourth aspect of the present disclosure provides a method for manufacturing a flexible flat cable (FFC), the method comprising: a coating film preparation step for preparing an upper insulating coating film and a lower insulating coating film, wherein each of the upper insulating coating film and the lower insulating coating film is made of an organic resin; a wire supply step for supplying a plurality of conducting wires into between the upper insulating coating film and the lower insulating coating film; a lamination step for bonding the upper insulating coating film and the lower insulating coating film to each other; a slitting step for cutting both ends of a stack of the upper and lower insulating coating films in a width direction thereof; and a cutting step for cutting the stack of the upper and lower insulating coating films and the plurality of conducting wires along a cutting line formed on the stack, wherein the coating film preparation step further includes: defining a portion of the upper insulating coating film as a region corresponding to a single FFC, wherein the region includes a first region and a second region for forming the cutting line, and a third region for bending; and perforating the upper insulating coating film in the first region, the second region and the third region; wherein the cutting line extends along a width direction of the upper insulating coating film and on at least one of the first region or the second region, wherein the third region is contained in a single upper insulating coating film cut individually along the cutting line, wherein each of the plurality of conducting wires include one of iron (Fe), sludge metal, and aluminum (Al), and has a thickness of 0.2 mm to 0.5 mm and a width of 0.05 mm to 0.15 mm.

In one implementation of the method of the fourth aspect, the coating film preparation step further includes perforating a region of the lower insulating coating film opposite to the first region or the second region.

In one implementation of the method of the fourth aspect, the coating film preparation step further includes perforating a region of the lower insulating coating film opposite to the third region.

In one implementation of the method of the fourth aspect, the organic resin includes one of PI (Poly Imide), PET (Polyethylene Terephthalate), PEN (Poly Ethylene Napthalene), or PCT (Polycyclohexylenedimethylene Teraphthlate).

In one implementation of the method of the fourth aspect, the lamination step includes: a first lamination step in which heat of a temperature within a range of 100° C. to 110° C. and a pressure within a range of 1 kgf/cm² to 3 kgf/cm² are applied to the upper insulating coating film and the lower insulating coating film; and a second lamination step in which heat of a temperature in the range of 140° C. to 160° C. and a pressure in a range of 90 kgf/cm² to 110 kgf/cm² are applied to the upper insulating coating film and the lower insulating coating film.

In one implementation of the method of the fourth aspect, the lamination step further includes a third lamination step for compressing a reinforcing film onto a region of the lower insulating coating film opposite to the first region or the second region.

In one implementation of the method of the fourth aspect, the third lamination step occurs at a temperature within a range of 110° C. to 130° C. and a pressure within a range of 1 kgf/cm² to 3 kgf/cm².

In one implementation of the method of the fourth aspect, the coating film preparation step further includes: an ultraviolet based pre-treatment step for irradiating ultraviolet rays to the upper insulating coating film and the lower insulating coating film; and bonding a primer and an adhesive to each of the upper insulating coating film and the lower insulating coating film irradiated with the ultraviolet rays.

In one implementation of the method of the fourth aspect, the ultraviolet ray has a wavelength in a range of 170 nm to 180 nm.

In one implementation of the method of the fourth aspect, the method further comprises wrapping an outer face of the cut stack of the upper and lower insulating coating films with an insulating tube.

A fifth aspect of the present disclosure provides a flexible flat cable (FFC) for transmitting an electrical signal or electrical energy, the FFC comprising: a film type main body extending in a length direction thereof and having both ends in the length direction; and a terminal formed at each of the both ends of the film type main body, wherein the film type main body includes: upper and lower insulating coating layers made of an organic resin; a plurality of conducting wires spaced apart from each other by a predetermined spacing and arranged in a width direction of the main body, wherein the plurality of conducting wires are disposed between the upper and lower insulating coating layers; an adhesive filled into between the upper and lower insulating coating layers while surrounding the plurality of conducting wires to fix the plurality of conducting wires; and an opening defined in a predefined region of the upper and/or lower insulating coating layers, wherein predefined regions of the plurality of conducting wires are exposed to an outside through the opening, wherein each of the plurality of conducting wires includes one of iron (Fe), sludge metal, and aluminum (Al).

In one implementation of the FFC of the fifth aspect, the film type main body is obtained using: a first lamination process in which heat of a temperature within a range of 100° C. to 110° C. and a pressure within a range of 1 kgf/cm² to 3 kgf/cm² are applied to the insulating coating layers; and then a second lamination process immediately after the first lamination process in which heat of a temperature within a range of 140° C. to 160° C. and a pressure within a range of 90 kgf/cm² to 110 kgf/cm² are applied to the insulating coating layers.

In one implementation of the FFC of the fifth aspect, the terminal further includes a reinforcing film connected to one of the upper and lower insulating coating layers, wherein the reinforcing film is formed using a third lamination process in which a temperature in a range of 110° C. to 130° C. and a pressure in a range of 1 kgf/cm² to 3 kgf/cm² are applied to the reinforcing film and each of the insulating coating layers.

In one implementation of the FFC of the fifth aspect, each of the plurality of conducting wires has a thickness of 0.2 mm to 0.5 mm and a width of 0.05 mm to 0.15 mm.

In one implementation of the FFC of the fifth aspect, the organic resin includes one of PI (Poly Imide), PEN (Poly Ethylene Napthalene), or PCT (Polycyclohexylenedimethylene Teraphthlate).

In one implementation of the FFC of the fifth aspect, the adhesive includes polyester.

A sixth aspect of the present disclosure provides a stack-type busbar comprising a vertical stack of a first FFC (flexible flat cable) and a second FFC, wherein each of the first FFC and the second FFC includes: a film type main body extending in a length direction thereof and having both ends in the length direction; and a terminal formed at each of the both ends of the film type main body, wherein the film type main body includes: upper and lower insulating coating layers made of an organic resin; a plurality of conducting wires spaced apart from each other by a predetermined spacing and arranged in a width direction of the main body, wherein the plurality of conducting wires are disposed between the upper and lower insulating coating layers; an adhesive filled into between the upper and lower insulating coating layers while surrounding the plurality of conducting wires to fix the plurality of conducting wires; and an opening defined in a predefined region of the upper and/or lower insulating coating layers, wherein predefined regions of the plurality of conducting wires are exposed to an outside through the opening, wherein each of the plurality of conducting wires includes one of iron (Fe), sludge metal, and aluminum (Al), wherein the opening of the first FFC and the opening of the second FFC are stacked one on top of another and are aligned with each other in a line parallel to a direction in which the first and second FFCs are stacked one on top of another.

In one implementation of the busbar of the sixth aspect, the busbar further comprises a connection terminal disposed at each of both longitudinal ends of the stack-type busbar, wherein the connection terminal is electrically connected to a first terminal of the first FFC and a second terminal of the second FFC, wherein the first and second terminals define the both longitudinal ends of the stack-type busbar, respectively.

In one implementation of the busbar of the sixth aspect, the stack-type busbar further comprises an insulating tube surrounding an outer surface of the stack-type busbar.

In one implementation of the busbar of the sixth aspect, the opening of the first FFC is positioned between two terminals of the first FFC, and the opening of the second FFC is positioned between two terminals of the second FFC.

The FFC according to the embodiments has the insulating coating layer formed by laminating the PCT film, thereby to reduce the weight of the FFC, and improve the thermal emissivity of the FFC.

Further, the FFC according to the embodiments includes a metal structure made of not only copper but also various metal conductors such as sludge metal (for example, iron (Fe), so that the manufacturing cost thereof may be reduced.

Further, the FFC according to the embodiments includes the metal structure whose cross-sectional area is adjusted, such that the thermal resistance of the metal structure may be lowered. The FFC according to the embodiments may include the adhesive made of the material having high thermal emissivity to maintain the temperature of the FFC at a constant level.

Moreover, the stack-type busbar according to the embodiments has a stacked structure capable of improving heat dissipation efficiency even though the plurality of FFCs are vertically stacked.

Moreover, in the FFC or stack-type busbar according to the embodiments, the predefined region of the insulating film layer may be removed to define the opening, so that when the FFC or the stack-type busbar is bent, a thickness of a portion to be bent may be reduced, and thus flexibility of a bending angle may be increased.

Moreover, the effect of the present disclosure is not limited to the above effects. It should be understood to include all possible effects derived from descriptions of the present disclosure or a configuration as set forth in the claims.

### BRIEF DESCRIPTIONS OF DRAWINGS

FIG. 1 is a schematic side view of a flexible flat cable (FFC) according to embodiments.

FIG. 2 is a cross-sectional view in a long side direction of the FFC according to the embodiments.

FIG. 3 is a graph of each of I²(x) and a reserve resistance R(x) based on a parameter x for a power loss Pₗₒₛₛ.

FIG. 4 is a cross-sectional view in a short side direction of the FFC according to embodiments.

FIG. 5 shows a FFC manufacturing method using a PCT film as an insulating coating layer according to embodiments.

FIG. 6 is cross-sectional views showing portions A and B of FIG. 5.

FIG. 7 shows a FFC manufacturing method using a PCT film as an insulating coating layer according to embodiments.

FIG. 8 shows a FFC manufacturing method using a PCT film as an insulating coating layer according to embodiments.

FIG. 9 shows a FFC manufacturing method using a PCT film as an insulating coating layer according to embodiments.

FIG. 10 is a diagram showing a structure of a stack-type busbar according to embodiments.

FIG. 11 is a schematic side view of a stack-type busbar according to embodiments.

FIG. 12 is a cross-sectional view of a stack-type busbar according to embodiments.

FIG. 13 is a cross-sectional view of a stack-type busbar according to embodiments.

FIG. 14 is a cross-sectional view of a stack-type busbar according to embodiments.

FIG. 15 is a cross-sectional view of a stack-type busbar according to embodiments.

FIG. 16 is a cross-sectional view of a stack-type busbar according to embodiments.

FIG. 17 is a cross-sectional view of a stack-type busbar according to embodiments.

FIG. 18 is a cross-sectional view of a stack-type busbar according to embodiments.

FIG. 19 shows a stack-type busbar according to embodiments.

FIG. 20 is an example of a stack-type busbar according to embodiments.

FIG. 21 is a flow chart showing a method for manufacturing a FFC according to embodiments.

FIG. 22 is a flow chart showing a method for manufacturing a FFC according to embodiments.

FIG. 23 is a top view of a film type cable according to embodiments.

FIG. 24 is a perspective view of an FFC according to embodiments.

FIG. 25 is an example of a stack-type busbar according to embodiments.

### DETAILED DESCRIPTION

For simplicity and clarity of illustration, elements in the figures are not necessarily drawn to scale. The same reference numbers in different figures represent the same or similar elements, and as such perform similar functionality. Further, descriptions and details of well-known steps and elements are omitted for simplicity of the description. Furthermore, in the following detailed description of the present disclosure, numerous specific details are set forth in order to provide a thorough understanding of the present disclosure. However, it will be understood that the present disclosure may be practiced without these specific details. In other instances, well-known methods, procedures, components, and circuits have not been described in detail so as not to unnecessarily obscure aspects of the present disclosure.

Examples of various embodiments are illustrated and described further below. It will be understood that the description herein is not intended to limit the claims to the specific embodiments described. On the contrary, it is intended to cover alternatives, modifications, and equivalents as may be included within the spirit and scope of the present disclosure as defined by the appended claims.

The terminology used herein is for the purpose of describing particular embodiments only and is not intended to limit the present disclosure. As used herein, the singular forms “a” and “an” are intended to include the plural forms as well, unless the context clearly indicates otherwise. It will be further understood that the terms “comprises”, “comprising”, “includes”, and “including” when used in this specification, specify the presence of the stated features, integers, operations, elements, and/or components, but do not preclude the presence or addition of one or more other features, integers, operations, elements, components, and/or portions thereof. As used herein, the term “and/or” includes any and all combinations of one or more of the associated listed items. Expression such as “at least one of” when preceding a list of elements may modify the entirety of list of elements and may not modify the individual elements of the list.

It will be understood that, although the terms “first”, “second”, “third”, and so on may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section described below could be termed a second element, component, region, layer or section, without departing from the spirit and scope of the present disclosure.

In addition, it will also be understood that when a first element or layer is referred to as being present “on” or “beneath” a second element or layer, the first element may be disposed directly on or beneath the second element or may be disposed indirectly on or beneath the second element with a third element or layer being disposed between the first and second elements or layers.

It will be understood that when an element or layer is referred to as being “connected to”, or “coupled to” another element or layer, it may be directly on, connected to, or coupled to the other element or layer, or one or more intervening elements or layers may be present. In addition, it will also be understood that when an element or layer is referred to as being “between” two elements or layers, it may be the only element or layer between the two elements or layers, or one or more intervening elements or layers may also be present.

Further, as used herein, when a layer, film, region, plate, or the like is disposed “on” or “on a top” of another layer, film, region, plate, or the like, the former may directly contact the latter or still another layer, film, region, plate, or the like may be disposed between the former and the latter. As used herein, when a layer, film, region, plate, or the like is directly disposed “on” or “on a top” of another layer, film, region, plate, or the like, the former directly contacts the latter and still another layer, film, region, plate, or the like is not disposed between the former and the latter. Further, as used herein, when a layer, film, region, plate, or the like is disposed “below” or “under” another layer, film, region, plate, or the like, the former may directly contact the latter or still another layer, film, region, plate, or the like may be disposed between the former and the latter. As used herein, when a layer, film, region, plate, or the like is directly disposed “below” or “under” another layer, film, region, plate, or the like, the former directly contacts the latter and still another layer, film, region, plate, or the like is not disposed between the former and the latter.

Unless otherwise defined, all terms including technical and scientific terms used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

A cable described based on embodiments, for example, FFC refers to a conductor that enables electrical connection between components. The cable according to embodiments may be used for electric vehicles, hydrogen electric vehicles, eco-friendly vehicles such as hybrid vehicles, battery packs, military transport equipment, manned/unmanned drones, helicopters, fighters, ESS (Energy Storage Station), solar cells, power transmission lines, ships, building (for example, apartments), etc. However, it will be readily apparent to those of ordinary skill in the art that the cable according to embodiments may be applied to any device which will be developed in the future and in which the cable may be installed. The cable according to embodiments may be referred to as a busbar.

A stack-type busbar as described based on embodiments refers to a stack of cables or FFCs. For example, the stack type busbar according to embodiments has a stack structure of one or more busbars.

Hereinafter, a long side direction of the FFC is referred to as an X-axis direction, a short side direction of the FFC is referred to an Y-axis direction, and a stacking direction of the FFCs is referred to as a Z-axis direction.

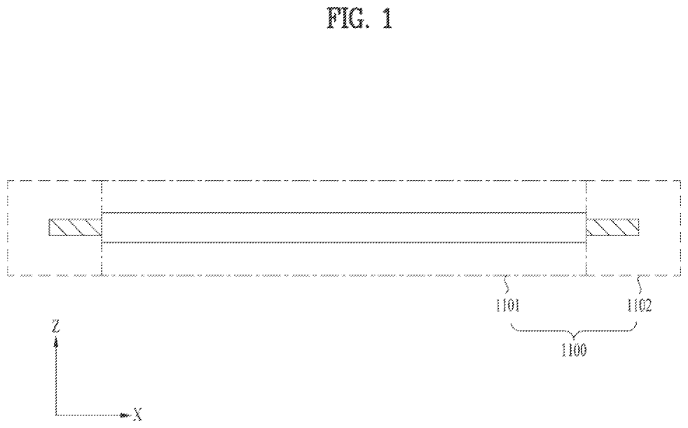

FIG. 1 is a schematic side view of a flexible flat cable (FFC) according to embodiments.

As shown in FIG. 1, a FFC 1100 according to the embodiments may include a main body 1101 and a terminal 1102 at each of both ends of the main body 1101. The main body 1101 may be formed to include an insulator. The terminal 1102 may be formed to include a conductor. That is, the FFC 1100 may be electrically connected to other electronic components, electronic devices, or electric devices through the terminal 1102. A protective cover (not shown) may cover an outer face of the main body 1101 to protect the FFC 1100.

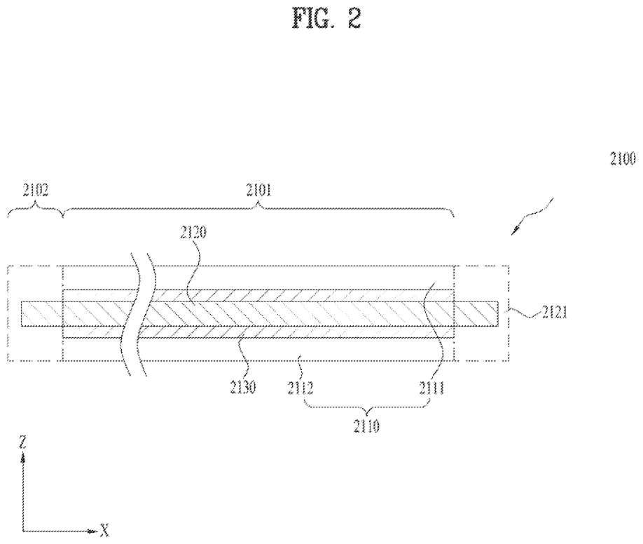

FIG. 2 is a cross-sectional view in the long side direction of the FFC according to the embodiments.

As shown in FIG. 2, a FFC 2100 according to the embodiments (for example, the FFC as described above with reference to FIG. 1) may include two insulating coating layer 2110, a plurality of metal structures 2120 disposed between the two insulating coating layer 2110, and an adhesive 2130. That is, the adhesive 2130 is filled into between the two insulating coating layers 2110 while fixing the plurality of metal structures 2120. Although only one metal structure 2120 is shown in FIG. 2, the disclosure is not limited thereto. The FFCE may include a plurality of metal structures.

The insulating coating layer 2110 according to the embodiments may be embodied as a polyethylene terephthalate (PET) film, a, polycyclohexylene dimethylene terephthalate (PCT) film, and the like.

The insulating coating layer 2110 according to the embodiments has a thermal emissivity of 0.7 or greater to 1 or smaller, preferably 0.75 or greater to 1 or smaller, and particularly preferably, 0.8 or greater to 1 or smaller. Since the insulating coating layer 2110 is installed on an outermost face of the FFC 2100, the thermal emissivity of the insulating coating layer 2110 is preferably greater than that of each of the metal structure 2120 and the adhesive 2130. In particular, it is desirable that the thermal emissivities of the metal structure 2120, the adhesive 2130, and the insulating coating layer 2110 increase in this order. That is, the heat dissipation efficiency is improved by increasing the thermal emissivity at the outside face of the FFC 2100. The metal structure 2120 in FIG. 2 is shown as a single metal structure. The disclosure is not limited thereto. One or more metal structures may be included therein.

The adhesive 2130 according to the embodiments may include, for example, polyester, acrylic, epoxy, or the like.

The adhesive 2130 according to the embodiments is not limited to the above-described example. Any material with excellent chemical resistance, scratch resistance, weather resistance, heat resistance, etc. may be used as the adhesive 230. For example, the adhesive may include a PCT copolymer in which PCT was copolymerized with ethylene glycol (EG) so as to add impact resistance, compared to the PET or PCT material.

The FFC 2100 according to the embodiments may further include a primer (not shown) between the insulating coating layer 2110 and the insulating layer 2120. When applying the primer, the adhesion between the insulating coating layer 2110 and the adhesive 2130 may be improved.

A primer (not shown) may be further included between the insulating coating layer 2110 and the adhesive 2130. When applying the primer, the adhesion between the insulating coating layer 2110 and the adhesive 2130 may be improved.

The FFC 2100 according to embodiments may further include a metal clad 2121 protruding from the insulating coating layer 2110. That is, in the FFC 2100 according to the embodiments, the metal clad 2121 of the metal structure 2120 may be exposed to the outside at both ends in the x-axis direction. When a plurality of FFC 2100s exist, metal dads 2121 of adjacent FFCs 2100 may contact each other. In this connection, adjacent metal dads 2121 may directly contact each other or may be connected to each other via bonding. Alternatively, the adjacent metal clads 2121 may be connected to each other via a conductive adhesive (not shown). For example, when there are a plurality of FFCs 2100, the metal structures 2120 included in adjacent FFCs 2100 may be electrically connected to each other via the metal clad 2121. The metal clad 2121 may refer to the terminal 2102, for example, the terminal as described above with reference to FIG. 1.

When increasing a surface area of the multiple metal structures 2120, the heat dissipation effect of the FFC 2100 increases, and a weight thereof may be reduced. Hereinafter, a process of determining a cross-sectional area or a surface area of a metal structure at which amounts of current and power are optimized and the heat dissipation effect of the FFC increases will be described.

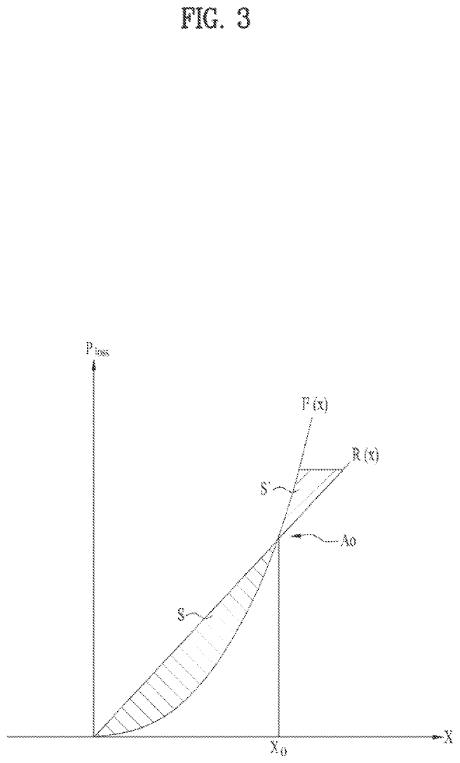

FIG. 3 is a graph of each of I²(x) and a reserve resistance R(x) based on a parameter x for a power loss Pₗₒₛₛ.

The FFC according to embodiments (for example, the FFC as described above with reference to FIGS. 1 to 2) may deliver power. For example, the FFC may transfer power between two electronic devices.

When the FFC supplies power, an entirety of applied power Pₐₚₚₗᵢ supplied to the FFC is not used as real power pᵣₑₐₗ of the FFC. Power loss Pₗₒₛₛ as a loss of electrical energy may occur in the delivery process. [Equation 1] denotes a relationship between the applied power and the power loss.

Pᵣₑₐₗ=Pₐₚₚₗᵢ−Pₗₒₛₛ [Equation 1]

In [Equation 1], Pᵣₑₐₗ denotes real power, Pₐₚₚₗᵢ denotes applied power, and Pₗₒₛₛ denotes power loss.

The real power Pᵣₑₐₗ may be expressed as [Equation 2].

Pᵣₑₐₗ=1−rPₐₚₚₗᵢ [Equation 2]

In [Equation 2], r is a constant representing a relationship between the applied power and the real power.

The FFC according to the embodiments has thermal energy corresponding to the power loss Pₗₒₛₛ expressed in the Equation. The thermal energy is released to the outside of the busbar via heat transfer, heat conduction, convection and heat dissipation.

Heat conduction refers to transfer of heat via a material. A measure of easiness of heat transfer via the material refers to inherent thermal conductivity thereof. Convection refers to heat transfer via fluid flow. Heat dissipation refers to heat transfer via electromagnetic waves. A measure of easiness of heat dissipation through a material refers to specific thermal emissivity thereof. While it is assumed that there is no influence such as convection in the heat transfer through FFC, the specific thermal emissivity and the thermal conductivity may be considered in the heat transfer through FFC. When the thermal conductivity of the material is large, a heat conduction amount therethrough is large. The greater the heat thermal emissivity of the material, the greater the heat dissipation therefrom is large.

Therefore, it is preferable that the conductor included in the FFC is a conductor having high thermal conductivity and high thermal emissivity for heat dissipation.

Each of a plurality of metal structures according to embodiments, for example, the metal structures as described above with reference to FIG. 2 may include a conductor having excellent electrical conductivity. According to the graph shown in FIG. 3, a type of the conductor to be included in the metal structure may be determined. In FIG. 3, Pₗₒₛₛ denotes the power loss, I²(x) denotes a square of current I for a parameter x, and R(x) denotes a resistance.

The power loss Pₗₒₛₛ may be expressed as a following [Equation 3] using the current I and the resistance R.

Pₗₒₛₛ=rI²R [Equation 3]

In [Equation 3], I denotes the current and R denotes the resistance.

As the current I increases, the real power Pᵣₑₐₗ increases. However, as may be seen in [Equation 3], as the current I increases, the power loss Pₗₒₛₛ also increases. For the design of the FFC according to the embodiments, a current I value having a maximum magnitude while suppressing the power loss Pₗₒₛₛ should be considered. That is, the maximum current I at which the current loss of the FFC according to the embodiments is reduced may be considered.

[Equation 3] may be expressed as following [Equation 4] using the parameter x.

I²(x)=a₁x²+b₁x+c₁

R(x)=b₂x+c₂ [Equation 4]

In [Equation 4], I²(x) refers to an equation of a square of the current I for the parameter x. R(x) represents an equation of the resistance R for the parameter x. a₁, b₁, b₂, c₁, and c₂ are constants.

In the graph shown in FIG. 3, the power loss Pₗₒₛₛ expressed in [Equation 4] is expressed as each of the square of the current I²(x) for the parameter x, and the resistance R(x) for the parameter x.

As may be seen in the graph shown in FIG. 3, there is a point A₀ where a curve of I²(x) and a straight line of R(x) meet each other. In a region S left to the point A₀ and a region S′ right to the point A₀, the real power pᵣₑₐₗ is greater than the power loss Pₗₒₛₛ. However, the regions S and S′ have different factors causing the current loss Ploss. In the region S, a value of the resistance R(x) is larger than a value of the square of the current I²(x), and thus the resistance component may be a dominant factor causing the power loss Pₗₒₛₛ. On the other hand, in the region S′ right to the point A₀, a value of the resistance R(x) is smaller than a value of the square of the current I²(x), and thus the current component may be a dominant factor causing the power loss Pₗₒₛₛ.

That is, it may be seen based on the graph shown in FIG. 3 that the S′ region has a large current loss. Accordingly, the metal structure according to the embodiments may include a conductor capable of reducing the power loss using the current I value corresponding to region S.

The metal structure may include a metal as a conductor, for example, copper (Cu).

In the region S, a total resistance may include specific resistance and thermal resistance. In this connection, percentages of the specific resistance and the thermal resistance in the total resistance are expressed as electrical resistance and thermal conductivity in [Table 1] below. The electrical resistance and the electrical conductivity have an inverse relationship.

TABLE 1

| Metal | Electrical resistance | Thermal conductivity |
|---|---|---|
| types | (at 293K, μΩcm) | (Wm⁻¹ K⁻¹) |
| Sliver | 1.63 | 419 |
| Copper | 1.694 | 397 |
| Aluminum | 2.67 | 238 |
| Iron | 10.1 | 78 |
| Tin | 12.6 | 73 |

[Table 1] shows the electrical resistance and thermal conductivity of each of silver, copper, aluminum, iron, and tin. [Table 1] shows data about only silver, copper, aluminum, iron, and tin in consideration of the total resistance and the cost thereof. However, the metal included in the metal structure according to the embodiments is not limited thereto and may include any material acting as the conductor. As shown in [Table 1], it may be seen that the percentage of the thermal resistance in the total resistance is large enough to ignore the percentage of the specific resistance. Therefore, the metal structure according to the embodiments may be selected in consideration of the thermal resistance. In this connection, the thermal resistance may vary based on a temperature variation. That is, it is preferable that in order to maintain the temperature change, the metal structure included in the FFC according to the embodiments dissipates the heat to maintain a constant temperature.

[Table 2] below shows the above [Table 1] based on the relative electrical conductivity and thermal conductivity of the metal conductor.

TABLE 1

| Metal | Relative electrical | Relative thermal |
|---|---|---|
| types | conductivity (Copper = 100) | conductivity (Copper = 100) |
| Sliver | 104 | 106 |
| Copper | 100 | 100 |
| Aluminum | 63 | 60 |
| Iron | 17 | 20 |
| Tin | 13 | 18 |

[Table 2] shows the relative electrical conductivity and thermal conductivity between silver, copper, aluminum, iron, and tin in the region S. Copper has excellent low resistance and has an advantage in terms of the electrical conductivity, and is used as the metal structure included in FFC, but a cost thereof is high and the copper is heavy in weight. Therefore, [Table 2] shows the relative electrical conductivity and thermal conductivity of the remaining metals except for the copper when each of the electrical conductivity of the copper and the thermal conductivity of copper is defined as 100. The relative electrical conductivity and thermal conductivity of silver are higher than those of copper, but the relative electrical conductivity and thermal conductivity of each of the other metals, that is, aluminum, iron and tin are lower than those of the copper. That is, it may be seen that in the region S, the difference between the thermal resistances of the metal conductors is not large.

Accordingly, each of the plurality of metal structures according to embodiments may include at least one of iron (Fe), sludge metal, or aluminum (Al) based on the graph as described above with reference to FIG. 3 and the above related Equations. Iron (Fe), sludge metal, and aluminum (Al) are relatively inexpensive compared to copper and thus allows the manufacturing cost of the FFC to be reduced. Further, in the region S, any metal material acting as the conductor having high thermal resistance other than the above listed materials may be used for the metal structure.

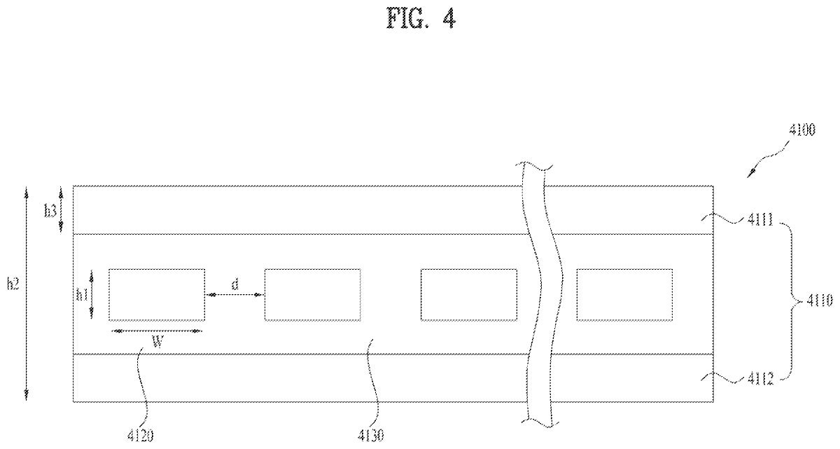

FIG. 4 is a cross-sectional view in the short side direction of the FFC according to embodiments.

A FFC 4100 according to embodiments (for example, the FFC as described above with reference to FIG. 1 to FIG. 3) may include two insulating coating layer 4110 (for example, the insulating coating layers as described above with reference to FIGS. 2 to 3), a plurality of metal structures 4120 disposed between the two insulating coating layers 4110 (for example, the metal structures as described above with reference to FIGS. 2 to 3), and an adhesive 4130 (for example, the adhesive as described above with reference to FIG. 2 to FIG. 3. Descriptions of overlapping configurations therebetween may refer to the above descriptions.

As shown in FIG. 4, the FFC according to the embodiments includes the plurality of metal structures 4120 which are disposed between the two insulating coating layers 4110 and are arranged and spaced apart from each other by a predetermined spacing d, for example, a first spacing d. Since the multiple metal structures 4120 have a smaller weight than that of the bulk metal structure, a proportion of the metal structures in the FFC is reduced. Accordingly, the FFC according to the embodiments may be not only lighter than the FFC including the bulk metal structure (hereinafter, referred to as “rigid FFC”, but also may reduce the manufacturing cost thereof.

Further, the metal structures 4120 according to the embodiments may be disposed between the two insulating coating layers 4110 to reduce heat loss. Specifically, since a long side of the metal structure 4120 according to the embodiments is parallel to a length direction of each of the two insulating coating layers 4110, an area where each metal structure 4120 and the two insulating coating layers 4110 overlap each other may be increased.

A cross-sectional shape of the metal structure 4120 according to embodiments may be a rectangular shape. When the cross-sectional shape of the metal structure 4120 is the rectangular shape, the long side of the rectangular shape parallel to a length direction of the insulating coating layer, that is, to the X-axis direction, and the short side of the rectangle is perpendicular to the length direction of the insulating coating layer 4110, that is, extends in the Z-axis. When constructing the metal structure 4120 in this way, an area where the metal structure 4120 and the insulating coating layers 4110 overlap each other is increased, and the heat loss and the current loss of the FFC 4100 may be reduced. However, the cross-sectional shape of the metal structure 4120 is not limited to the rectangle. The cross-sectional shape of the metal structure 4120 may be any shape, such as an oval, a circle, or a polygon.

When the cross-sectional shape of the metal structure 4120 according to the embodiments is the rectangular shape, a ratio of a length of the long side relative to a length of the short side thereof may be 5 times or greater, preferably 10 times or greater, and particularly preferably 50 times or greater. When the difference between the length in the short side direction and the length in the long side direction thereof increases, the overlapping area between the metal structure 4120 and each insulating coating layer 4110 may be increased at the same cross-sectional area. Therefore, as long as the rigidity of the metal structure 4120 may be maintained, the ratio of the length in the long side direction to the length in the short side direction thereof may be 100 times or greater.

W shown in the drawing represents a width of the metal structure, and h1 shown in the drawing represents a thickness of the metal structure. The width w of the metal structure according to the embodiments has a value in a range of 0.05 mm (50 um) to 0.15 mm (150 um), while the thickness h1 thereof has a value within a range of 0.2 mm (200 um) to 0.5 mm 500 um.

h2 shown in the drawing represents a thickness of the FFC 4100. h3 shown in the drawing represents a thickness of each insulating coating layer 4111 or 4112. For example, the thickness h2 of the FFC has a value in a range of 140 μm to 206 μm, while the thickness h3 of each insulating coating layer 4111 or 4112 has a value within a range of 25 μm to 38 μm. The values of the width w of the metal structure, the thickness h1 of the metal structure, the thickness h2 of the FFC, and the thickness h3 of each of the insulating coating layers 4111 and 4112 are not limited to the above values ranges.

The adhesive 4130 according to the embodiments may be filled into between the two insulating coating layers 4111 and 4112 while surrounding the plurality of metal structures 4120 to fix the plurality of metal structures 4120. In terms of heat loss, in a structure in which the plurality of metal structures 4120 are simply formed between the two insulating coating layers 4111 and 4112, air invading into the FFC 4100 according to the embodiments may be trapped therein. That is, the efficiency of the heat dissipation of the FFC due to the heat emission may be lowered by the intrusive air having low thermal emissivity. Accordingly, the FFC 4100 according to the embodiments may be formed so that a material having high thermal emissivity surrounds the metal structure 4120. Specifically, the FFC 4100 according to the embodiments may be constructed such that the adhesive 4130 having high thermal emissivity that may prevent air intrusion surrounds the plurality of metal structures 4120, while the plurality of metal structures 4120 and the two insulating coating layers 4110 are bonded to each other via the adhesive 4130.

Each of the two insulating coating layer 4110 and the adhesive 4130 according to the embodiments may be made of a material having higher thermal emissivity than that of each of the plurality of metal structures 4120 in order to improve the heat dissipation efficiency of the FFC. For example, the adhesive 4130 may include polyester. The FFC 4100 according to the embodiments may be configured such that the thermal emissivities of the material of the insulating coating layer 4110, the material of the adhesive 4130, and the material of the metal structure 4120 decrease in this order. Therefore, the insulating coating layer 4110 includes a material with relatively high thermal emissivity. The metal structure 4120 may include a material with relatively low thermal emissivity. However, the disclosure is not limited thereto. The materials of the insulating coating layer 4110, the adhesive 4130, and the metal structure 4120 may have the same thermal emissivity.

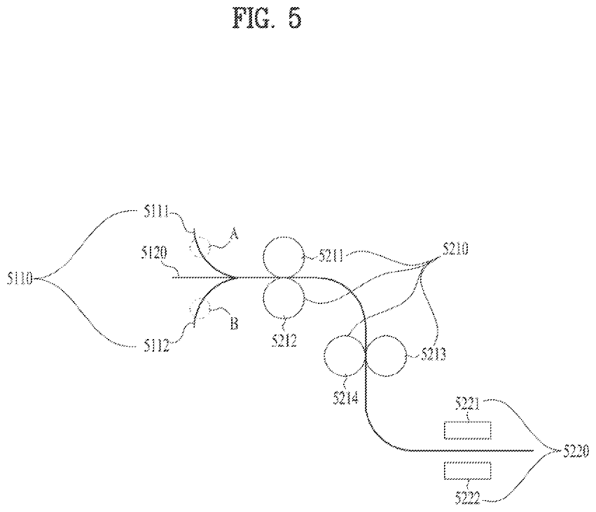

FIG. 5 to FIG. 9 shows the FFC manufacturing method according to the embodiments.

FIG. 5 shows the FFC manufacturing method according to embodiments.

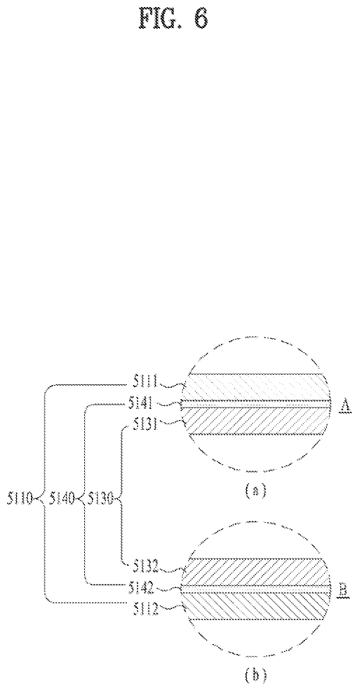

FIG. 6 is a cross-sectional view showing portions A and B of FIG. 5.

As described above with reference to FIG. 1 to FIG. 4, the insulating coating layer 5110 according to the embodiments (for example, the insulating coating layer 2110 as described above with reference to FIG. 2) includes a PCT film. The PCT film has higher heat resistance than that of PET film and has strong properties against high-temperature, high-humidity environments. That is, properties of the PCT film may not change under high-temperature and high-humidity conditions. Therefore, when forming a pattern on the PCT film using a printing method, long-term reliability of the FFC under high temperature and high humidity conditions may be improved, compared to that when forming a pattern on the conventional PET film using a printing method. However, it is difficult to use the PCT film as the insulating coating layer of the FFC because the adhesive strength between the PCT film and the adhesive is low. Hereinafter, a FFC manufacturing method in which the PCT film is used as the insulating coating layer of the FFC will be described.

The manufacturing method of the FFC according to the embodiments, for example, the FFC as described above with reference to FIGS. 1 to 4 includes a lamination process applied during a roll-to-roll process.

In the lamination process according to the embodiments, while a metal structure 5120 as a plurality of conductor wires (for example, the metal structure as described above with reference to FIGS. 2 to 4) may be supplied into between an upper insulating coating layer 5111 and a lower insulating coating layer 5112 (for example, the insulating coating layer as described above with reference to FIGS. 2 to 4), the metal structure may be laminated therebetween.

The insulating coating layer 5110 may include the upper insulating coating layer 5111 and the lower insulating coating layer 5112. A primer 5140 may include an upper primer 5141 and a lower primer 5142. The adhesive 5130 may include an upper adhesive 5131 and a lower adhesive 5132. Thus, as shown in FIG. 5, the upper primer 5141 may be interposed between the upper insulating coating layer 5111 and the upper adhesive 5131, while the lower primer 5142 may be interposed between the lower insulating coating layer 5112 and the lower adhesive 5132.

Each of the upper and lower insulating coating layers 5111 and 5112 refers to a member that will act as each of the upper and lower insulating coating layers 5150 of the FFC 5100. Each of the upper and lower insulating coating layers 5111 and 5112 may be embodied as a PCT film made of PCT. Further, each of the upper and lower primer layers 5141 and 5142 of the FFC may be made of polyurethane-based resin.

When the lamination process according to the embodiments is performed, the upper and lower insulating coating layers 5110 travels while the upper adhesive 5131 of the upper insulating coating layer 5111 and the lower adhesive 5132 of the lower insulating coating layer 5112 are in contact with each other. While the metal structures 5120 are continuously supplied into between the two adhesives 5131 and 5132, the metal structures 5120 may travel together with the upper and lower insulating coating layers 5111 and 5112.

The lamination process according to embodiments includes a first lamination process and a second lamination process.

In the first lamination process according to embodiments, the upper and lower insulating coating layers 5111 and 5112 and the metal structures 5120 travel in a horizontal direction and pass between a pair of first heating rollers 5211 and 5212 arranged vertically. In this connection, the first heating rollers 5211 and 5212 may apply heat of temperature within a range of 100° C. to 110° C. to the upper and lower insulating coating layers 5111 and 5112 and may apply a pressure in a range of 1 kgf/cm² to 3 kgf/cm² thereto. In the first lamination process, the upper and lower insulating coating layers 5111 and 5112 are pressed while alignment of the metal structures 5120 are maintained. Thus, relatively low temperature and low pressure are applied thereto.

In the second lamination according to the embodiments, immediately after the first lamination, the upper and lower insulating coating layers 5111 and 5112 and the metal structures 5120 travels in a vertical direction and pass between a pair of second heating rollers 5213 and 5214 arranged horizontally. In this connection, the second heating rollers 5213 and 5214 may apply heat of a temperature in a range of 140° C. to 160° C. and a pressure in a range of 90 kgf/cm² to 110 kgf/cm² to the upper and lower insulating coating layers 5111 and 5112.

In the second lamination according to embodiments, a case in which the upper and lower insulating coating layers 5111 and 5112 and the metal structures 5120 travel in a horizontal direction may be considered. In this case, when the high temperature heat applied to the lower insulating coating layer 5112 rises, thus affecting the upper insulating coating layer 5111, or when residual heat remaining on the lower insulating coating layer 5112 immediately after the second lamination rises to the upper insulating coating layer 5111, different temperature heats may be applied to the upper and lower insulating coating layers 5111 and 5112. Accordingly, in the second lamination according to embodiments, the upper and lower insulating coating layers 5111 and 5112 and the metal structures 5120 may travel not in the horizontal direction but in a vertical direction.

Alternatively, in the first lamination according to embodiments, the upper and lower insulating coating layers 5111 and 5112 and the metal structures 5120 may travel in a vertical direction. In this case, when the heat temperature increases due to the high temperature of the second heating rollers 5213 and 5214 to affect the environment of the first lamination temperature, the first lamination temperature condition may differ from a target temperature condition. Therefore, in the first lamination according to the embodiments, the upper and lower insulating coating layers 5111 and 5112 and the metal structures 5120 travel in a horizontal direction unlike in the second lamination.

A thickness of each of the upper and lower insulating coating layers 5111 and 5112 and a thickness of each of the metal structures 5120 according to the embodiments are appropriately selected so that a thickness of the FFC according to the embodiments is as described above.

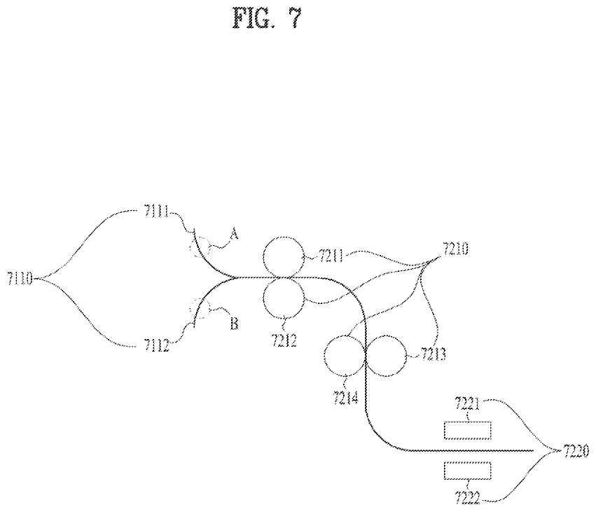

FIG. 7 shows a FFC manufacturing method according to embodiments.

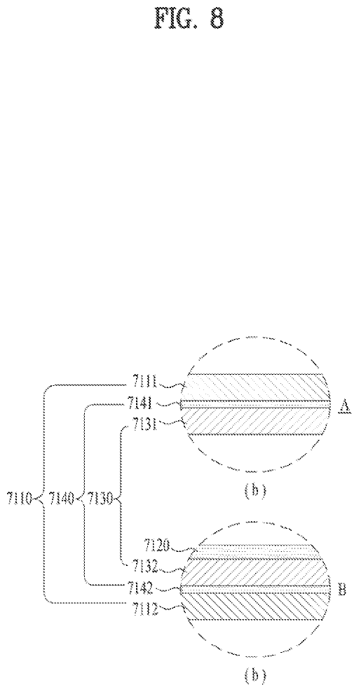

FIG. 8 is a cross-sectional view showing portions A and B of FIG. 7.

The manufacturing method of the FFC according to the embodiments, for example, the FFC as described above with reference to FIGS. 1 to 6 includes a lamination process applied during a roll-to-roll process.

Unlike FIG. 5, in FIG. 7, the metal structures (not shown) may be printed on one of upper and lower adhesives 7131 and 7132 respectively corresponding to upper and lower insulating coating layers 7111 and 7112 before the lamination process is performed. FIG. 7 and (b) in FIG. 8 show that the metal structures 7120 are printed on the lower adhesive 7132 corresponding to the lower insulating coating layer 7112.

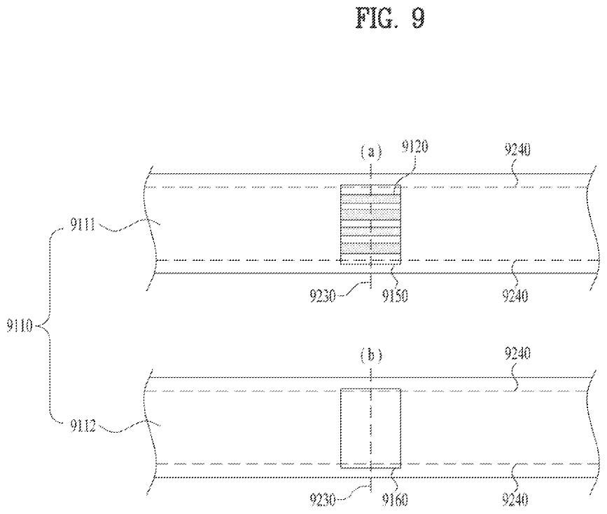

FIG. 9 is a plan view and a bottom view to describe a slitting process and a cutting process performed after the lamination process.

The lamination process according to embodiments, for example, the lamination process as described above with reference to FIGS. 5 to 8 may include a third lamination process performed after the second lamination process.

In the FFC according to the embodiments, for example, the FFC as described above with reference to FIGS. 1 to 8, both ends of each of metal structures 9120 (for example, the metal structures as described above with reference to FIGS. 2 to 8) may be exposed to the outside as described above for connection to a connector (not shown). To this end, an exposure window 9150 may be perforated in one of the upper and lower insulating coating layers 9111 and 9112 (for example, the insulating coating layer as described above with reference to FIGS. 2 to 8) before the lamination process.

After the upper and lower insulating coating layers 9111 and 9112 according to the embodiments (for example, the insulating coating layer as described above with reference to FIG. 2 to FIG. 8) having the exposure window 9150 perforated therein have been subjected to the first and second lamination processes, the third lamination process is performed. In the third lamination process, a reinforcing film 9160 is thermally compressed onto the insulating coating layer 9110 facing the exposure window 9150, that is, the other of the upper and lower insulating coating layers 9111 and 9112. The reinforcing film 9160 according to embodiments may be formed on an outer face of each of the two insulating coating layers 9110. Specifically, the reinforcing film 9160 according to the embodiments may be formed on an outer face of each of the two insulating coating layers 9110 opposite to the plurality of metal structures. As shown in FIG. 9, when the exposure window 9150 is perforated in the upper insulating coating layer 9111, the reinforcing film 9160 may be thermally pressed onto the lower insulating coating layer 9112 so that the film 9160 is located under the exposure window 9150.

In the third lamination process according to the embodiments, the upper and lower insulating coating layers 9111 and 9112 and the metal structures 9120 travel horizontally and continuously while passing between a pair of heating plates 5220 and 7220 arranged vertically (for example, the heating plates as described above with reference to FIGS. 5 to 8). The reinforcing film 9160 is periodically supplied and is thermally compressed to the insulating coating layer 9110 while being periodically pressed and heated by the heating plates 5220 and 7220. The heating plates 5220 and 7220 may apply heat of a temperature within a range of 100° C. to 110° C. and a pressure within a range of 1 kgf/cm² to 3 kgf/cm² to the insulating coating layer 9110 and the reinforcing film 9160.

The reinforcing film 9160 according to the embodiments has a structure in which an adhesive made of a polyester-based resin, for example, the adhesive as described above with reference to FIGS. 2 to 8 is adhered to one face of a PCT film or PET film.

After the third lamination process is achieved, the slitting process and the cutting process may take place sequentially. In the slitting process, both ends in a width direction of the insulating coating layer 9110 are cut along a slitting line 9240 as shown in FIG. 9. After the slitting process is performed, the insulating coating layer 9110 has a width smaller than that of the exposure window 9150. In the cutting process, the insulating coating layer 9110, the metal structures 9120, and the reinforcing film 9160 are cut along a cutting line 9230 located at a center of the exposure window 9150 in a length direction of the FFC.

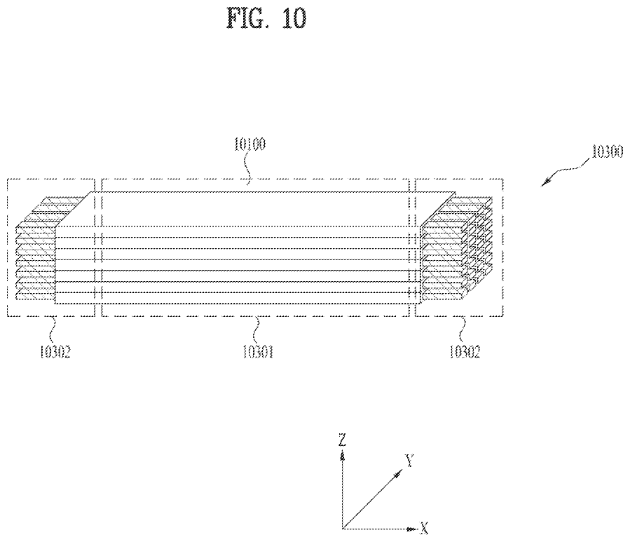

FIG. 10 is a diagram showing a structure of a stack-type busbar according to embodiments.

FIG. 10 is a perspective view of a stack-type busbar 10300 according to embodiments. The stack-type busbar 10300 according to embodiments has a structure in which a plurality of FFCs 10100 (e.g., FFC as described above with reference to FIG. 1 to FIG. 9) are stacked vertically. Further, hereinafter, a long side direction of the FFC is defined as the X-axis direction, a short side direction of the FFC is defined as the Y-axis direction, and the stacking direction of the FFC is defined as the Z-axis direction.

The stack-type busbar 10300 according to the embodiments includes a main body 10301 (e.g., including the main body as described above with reference to FIG. 1 to FIG. 9) and a terminal 10302 at each of both edges of the main body 10301 (e.g., including the terminal as described above with reference to FIG. 1 to FIG. 9. The main body 10301 acts as an insulator. The terminal 10302 acts as a conductor. That is, the stack-type busbar 10100 is electrically connected to other electronic components, electric devices or electronic devices via the terminal 10302. According to the embodiments, in order to protect the FFCs 10100, a protective cover (not shown) may be installed on an outer face of the main body 10301 of the stacked FFCs 10100.

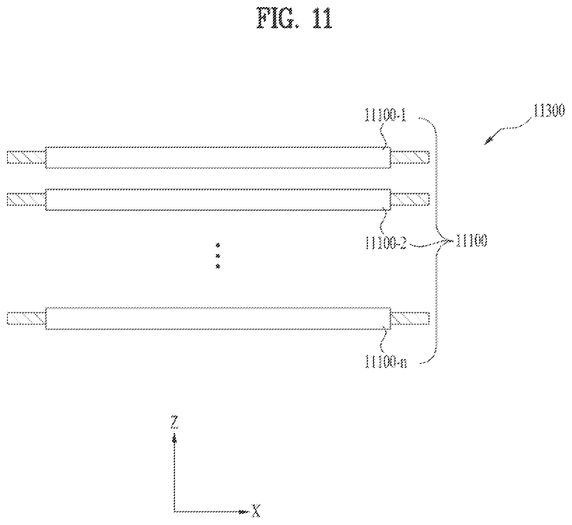

FIG. 11 is a schematic side view of a stack-type busbar according to embodiments.

As shown in FIG. 11, a stack-type busbar 11300 (for example, the stack-type busbar as described above with reference to FIG. 10) has multiple FFCs 11100-1, 11100-2, . . . 11100-n (e.g., including the FFCs as described above with reference to FIG. 1 to FIG. 10) as arranged in the Z-axis direction. In this connection, when the plurality of FFCs are not particularly distinguished from each other, the plurality of FFCs are collectively referred to as FFCs 11100 for convenience of the description. That is, in the stack-type busbar, FFCs as described above with reference to FIGS. 1 to 10 are stacked along n layers in the Z-axis direction.

FIG. 11 shows that adjacent FFCs are spaced apart from each other in the stack-type busbar 11300 for convenience of description. However, the adjacent FFCs do not need to be spaced apart from each other. That is, some of adjacent FFCs may be in contact with each other. Further, the adjacent FFCs may be adhered to each other via an adhesive.

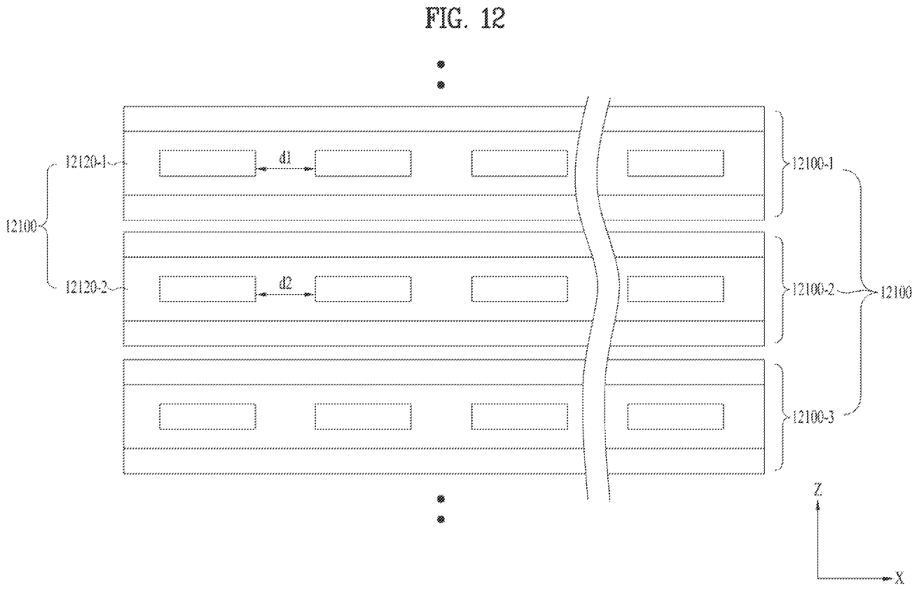

FIG. 12 is a cross-sectional view of a stack-type busbar according to embodiments.

A stack-type busbar 12300 according to embodiments, for example, the stack-type busbar as described above with reference to FIG. 10 to FIG. 11 includes a plurality of FFCs 12100, for example, FFCs as described above with reference to FIGS. 1 to 11. The plurality of FFCs 12100 according to embodiments may include a first FFC 12100-1 and a second FFC 12100-2. Each of the first and second FFCs 12100-1 and 12100-2 is the same as or similar to the FFC as described above with reference to FIGS. 1 to 11, and thus has the two insulating coating layers (for example, the PCT films as described above with reference to FIGS. 1 to 11), the plurality of metal structures (for example, the metal structures as described above with reference to FIGS. 1 to 11), and the adhesive (for example, the adhesive as described above with reference to FIGS. 1 to 11). The stack-type busbar 12300 according to embodiments has a structure in which the first FFC 12100-1 and the second FFC 12100-2 are stacked vertically. Further, the second FFC 12100-2 is stacked on a third FFC 12100-3. The third FFC 12100-3 according to the embodiments may be the same as the first FFC 12100-1, and may be the same as the second FFC 12100-2.

The stack-type busbar 12300 according to embodiments including the plurality of FFCs (collectively referred to as 12100) may be different from a busbar (hereinafter referred to as “rigid busbar”) including a bulk metal structure. However, in the stack-type busbar 12300 according to embodiments, a bulk metal structure is divided into the plurality of metal structures. For example, a single FFC having the plurality of metal structures as divided as described above with reference to FIG. 4 may constitute a single busbar. That is, the stack-type busbar 12300 according to the embodiments may have a reduced total amount of a metal occupied therein, compared to the rigid busbar, thereby implementing a lightweight stack-type busbar at a reduced cost.

Therefore, the stack-type busbar 12300 according to the embodiments has excellent flexibility because the plurality of divided metal structures are stacked, which is not the case in the rigid busbar. In the rigid busbar, when there is a bent portion, a significant amount of heat is generated in the bent portion when power is applied therethrough, thus dissipating a larger amount of power than when the rigid busbar is not bent. To the contrary, even when the stack-type busbar according to the embodiments is bent, there is substantially no power loss due to the bending. Therefore, the stack-type busbar 12300 according to the embodiments has many advantages over the rigid busbar. For example, the stack-type busbar 12300 may suppress rise in a temperature when a large current flows therein.

The stack-type busbar 12300 according to embodiments includes the first FFC 12100-1 and the second FFC 12100-2 stacked on the first FFC 12100-1.

Each of the first FFC 12100-1 and the second FFC 12100-2 may include the two insulating coating layers as described above with reference to FIG. 4 (for example, the two insulating coating layers as described above with reference to FIGS. 2 to 11) (for example, the two insulating coating layers 4111 and 4112 in FIG. 4), and the plurality of metal structures 12120 (for example, the plurality of metal structures 4120 as described above with reference to FIG. 4) arranged between the two insulating coating layers. The plurality of metal structures 12120 may be surrounded with and fixed to the adhesive, for example, the adhesive 4130 as described above with reference to FIG. 4. That is, the adhesive may be located between the insulating coating layer and the metal structure 12120 or between adjacent metal structures 12120. The structure of the FFC in the stack-type busbar 12300 according to embodiments is the same as that as described above with reference to FIG. 4, and thus the detailed description thereof is omitted.

Each of a first spacing d1 and a second spacing d2 shown in FIG. 12 represents a spacing between adjacent metal structures within the same FFC.

As shown in FIG. 12, a plurality of metal structures 12120-1 included in the first FFC 12100-1 according to embodiments may be disposed between the two insulating coating layers, and may be arranged in the Y direction and be spaced apart from each other by a first spacing d1.

As shown in FIG. 12, a plurality of metal structures 12120-2 included in the second FFC 12100-2 according to embodiments may be disposed between the two insulating coating layers, and may be arranged in the Y direction and be spaced apart from each other by a first spacing d2.

The second spacing d2 may be the same as or different from the first spacing d1. Although not shown in the drawing, the plurality of metal structures included in the third FFC 12120-3 according to embodiments may be disposed between the two insulating coating layers, and may be arranged in the Y direction and be spaced apart from each other by a third spacing. The third spacing may be the same as or different from the first spacing d1 and/or the second spacing d2.

The plurality of metal structures 12120 according to the exemplary embodiments are arranged and spaced apart from each other, thereby improving the heat dissipation effect of the FFC 12100.

A cross-sectional shape of each of the metal structure 12120 according to embodiments may be a rectangular shape. When the cross-sectional shape of the metal structure 12120 is the rectangular shape, the long side of the rectangular shape parallel to a length direction of the insulating coating layer, that is, to the X-axis direction, and the short side of the rectangle is perpendicular to the length direction of the insulating coating layer, that is, extends in the Z-axis. When constructing the metal structure 12120 in this way, an area where the metal structure 12120 and the insulating coating layers overlap each other is increased, and the heat loss and the current loss of the FFC 12100 may be reduced. However, the cross-sectional shape of the metal structure 12120 is not limited to the rectangle. The cross-sectional shape of the metal structure 12120 may be any shape, such as an oval, a circle, or a polygon.

When the cross-sectional shape of the metal structure 12120 according to the embodiments is the rectangular shape, a ratio of a length of the long side relative to a length of the short side thereof may be 5 times or greater, preferably 10 times or greater, and particularly preferably 50 times or greater. When the difference between the length in the short side direction and the length in the long side direction thereof increases, the overlapping area between the metal structure 12120 and each insulating coating layer may be increased at the same cross-sectional area. Therefore, as long as the rigidity of the metal structure 12120 may be maintained, the ratio of the length in the long side direction to the length in the short side direction thereof may be 100 times or greater.

The metal structure 12120 according to the embodiments may include at least one of iron (Fe), sludge metal, or aluminum (Al) as described above with reference to FIGS. 1 to 11. However, the disclosure is not limited thereto. Any metal acting as a conductor may be used for the metal structure 12120. Description of the overlapping configuration therebetween may refer to the above description.

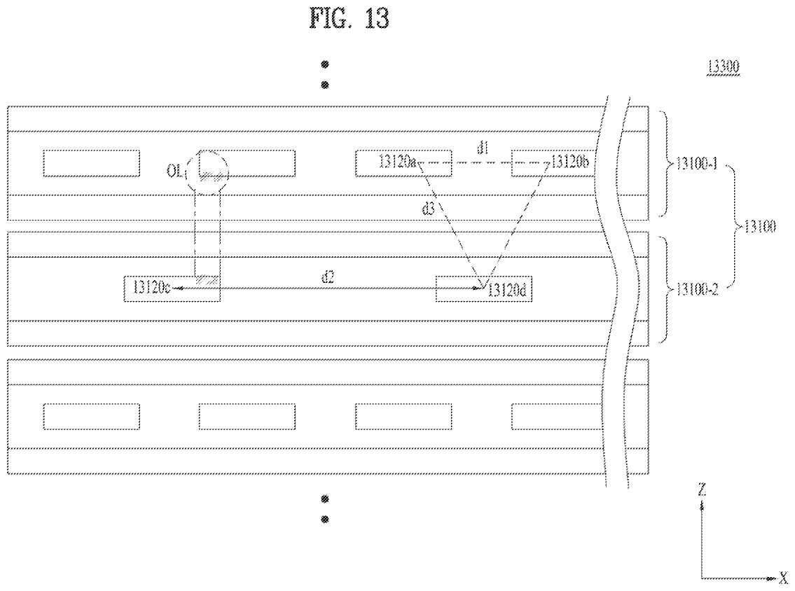

FIG. 13 is a cross-sectional view of a stack-type busbar according to embodiments.

A stack-type busbar 13300 according to embodiments (for example, the stack-type busbar as described above with reference to FIG. 10 to FIG. 12) may include a plurality of FFCs 13100 (for example, the FFCs as described above with reference to FIG. 1 to FIG. 12). The plurality of FFCs 13100 may include a first FFC 13100-1 and a second FFC 13100-2. Each of the first and second FFCs 13100-1 and 13100-2 may include two insulating coating layers, (for example, PCT films as described above with reference to FIGS. 1 to 12), a plurality of metal structures (for example, the metal structures as described above with reference to FIGS. 1 to 12), and an adhesive (for example, the adhesive as described above with reference to FIGS. 1 to 11). The overlapping configuration therebetween may refer to the above description. The stack-type busbar 13300 according to embodiments includes a stack of the first FFC 13100-1 and the second FFC 13100-2. The first FFC 13100-1 may include a plurality of metal structures 13120 spaced apart by a first spacing d1. The first spacing d1 according to the embodiments refers to a spacing between a center of one metal structure (hereinafter, a first metal structure 13120a) included in the first FFC 13100-1 and a center of another metal structure (hereinafter, a second metal structure 13120b) therein adjacent to the first metal structure. The second FFC 13100-2 may include a plurality of metal structures 13120 spaced apart by a second spacing d2. The second spacing d2 according to the embodiments refers to a spacing between a center of one metal structure (hereinafter, a third metal structure 13120d) included in the second FFC 13100-2 and a center of another metal structure (hereinafter, a fourth metal structure 13120c) therein adjacent to the third metal structure. The second spacing d2 according to embodiments may be greater than or equal to the first spacing d1.

The stack-type busbar 13300 according to the embodiments includes the first FFC 13100-1 and the second FFC 13100-2 stacked vertically such that a spacing between at least one of at least two adjacent metal structures included in the first FFC 13100-1 and any metal structure included in the second FFC 13100-2 has the shortest distance, so that internal heat in the busbar may be more efficiently discharged out of the busbar.

D3 in FIG. 13 refers to a third spacing which means the shortest spacing between the metal structure included in the first FFC 13100-1 and the metal structure included in the second FFC 13100-2. That is, the third spacing d3 according to embodiments refers to the shortest spacing between a center of the first metal structure 13120a included in the first FFC 13100-1 and a center of the third metal structure 13120d included in the second FFC 13100-2.

Accordingly, a spacing between the center of the first metal structure 13120a included in the first FFC 13100-1 and the center of the third metal structure 13120d included in the second FFC 13100-2 may be the third spacing d3. That is, the first FFC 13100-1 and the second FFC 13100-2 according to the embodiments may be stacked vertically such that an triangle is created by connecting the center of the first metal structure 13120a, the center of the second metal structure 13120b, and the center of the third metal structure 13120d with each other. The triangular structure according to the embodiments may be referred to as a delta structure.

Any metal structure included in the first FFC 13100-1, for example, the first metal structure 13120a, and any metal structure included in the second FFC 13100-2, for example, the third metal structure 13120d may at least partially overlap (OL) or may not overlap each other in the Z-axis direction, based on the first spacing d1, the second spacing d2 and/or the third spacing d3 according to the embodiments.

When any metal structure included in the first FFC 13100-1 and any metal structure included in the second FFC 13100-2 defining the triangular structure according to the embodiments at least partially overlap each other, the stack-type busbar 13300 may deliver power more effectively. To the contrary, when any metal structure included in the first FFC 13100-1 and any metal structure included in the second FFC 13100-2 defining the triangular structure according to the embodiments do not overlap each other, overlapping between the heat regions of layers of the stack may be minimized Therefore, the stack-type busbar 13300 may dissipate heat more effectively. As the first spacing d1, the second spacing d2 and/or the third spacing d3 according to the embodiments increases, any metal structure included in the first FFC 13100-1 and any metal structure included in the second FFC 13100-2 do not overlap each other in the z-axis direction.

The structure of the stack-type busbar 13300 according to the embodiments is not limited to the above-described example. In another example, a plurality of first FFCs 13100-1 and a plurality of second FFCs 13100-2 may be alternately and vertically stacked with each other. Alternatively, one first FFC 13100-1 and a plurality of second FFCs 13100-2 may be alternately and vertically stacked with each other. Alternatively, a plurality of first FFCs 13100-1 and one second FFC 13100-2 may be alternately and vertically stacked with each other. Alternatively, a third FFC different from the first FFC 13100-1 and the second FFC 13100-2, (for example, the third FFC 12100-3 as described above with reference to FIG. 12), and the first FFC 13100-1 and the second FFC 13100-2 may constitute a stack.

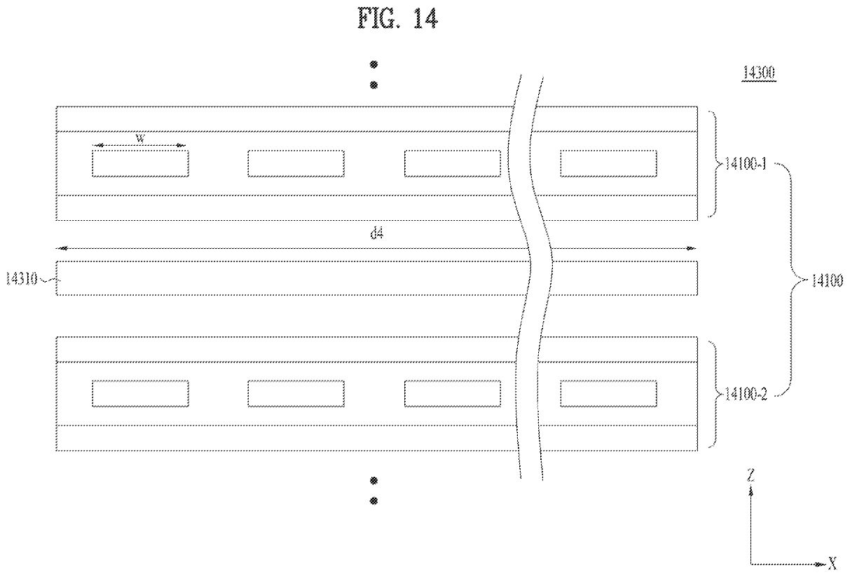

FIG. 14 is a cross-sectional view of a stack-type busbar according to embodiments.

A stack-type busbar 14300 according to embodiments (for example, the stack-type busbar as described above with reference to FIG. 10 to FIG. 13) may include a plurality of FFCs 14100 (for example, the FFCs as described above with reference to FIG. 1 to FIG. 13). The plurality of FFCs 14100 may include a first FFC 14100-1 and a second FFC 14100-2. Each of the first and second FFCs 14100-1 and 14100-2 may include two insulating coating layers, (for example, PCT films as described above with reference to FIGS. 1 to 13), a plurality of metal structures (for example, the metal structures as described above with reference to FIGS. 1 to 13), and an adhesive (for example, the adhesive as described above with reference to FIGS. 1 to 13). The overlapping configuration therebetween may refer to the above description.

The first FFC 14100-1 may include a plurality of metal structures spaced apart from each other by a first spacing, for example, the first spacing d1 as described above with reference to FIG. 12 to FIG. 13. The second FFC 14100-2 may include a plurality of metal structures spaced apart from each other by a second spacing, for example, the second spacing d2 as described above with reference to FIGS. 12 to 13. The second spacing according to the embodiments may be greater than or equal to the first spacing. The stack-type busbar 14300 according to the embodiments includes a meal planar plate 14310 disposed between at least two FFCs, for example, the first FFC 14100-1 and the second FFC 14100-2. d4 shown in FIG. 14 represents a length of the meal planar plate 14310 in a short side direction, that is, in the Y direction. w shown in FIG. 14 represents a length in the short side direction of the metal structure included in the FFC, for example, the first FFC 14100-1. d4 according to embodiments is greater than or equal to w. The stack-type busbar 14100 according to the embodiments may supply high power. Specifically, since a total area of the conductor region is increased due to the presence of the meal planar plate 14310, the number of the stacked FFCs 14100 included in the stack-type busbar 14300 according to the embodiments may be reduced. Therefore, the stack-type busbar 14300 including the meal planar plate 14310 as shown in FIG. 14 is more effective in high current or high power deliver situations.

The meal planar plate 14310 according to the embodiments includes a thin plate-shaped metal and/or a bulk metal. The meal planar plate 14310 may be made of the same material as the metal structure. For example, the metal structure and the meal planar plate 14310 may be made of iron (Fe). However, the disclosure is not limited thereto. The meal planar plate 14310 may be made of any metal as long as it acts as a conductor. For example, regardless of a metal type of the metal structure, the meal planar plate 14310 may be made of copper (Cu), aluminum (Al), silver (Ag), or the like.

A cross-sectional area along the z-axis direction of the meal planar plate 14310 according to the embodiments may be larger than the cross-sectional area in the z-axis direction of the metal structures 14120 included in the plurality of FFCs 14100. Specifically, a length of the metal structure in the y-axis direction as the short side direction may be smaller than a length of the meal planar plate 14310 in the y-axis direction as the short side direction. Further, the surface area of the meal planar plate 14310 may be smaller than a total surface area of the plurality of metal structures included in each of the plurality of FFCs 14100.

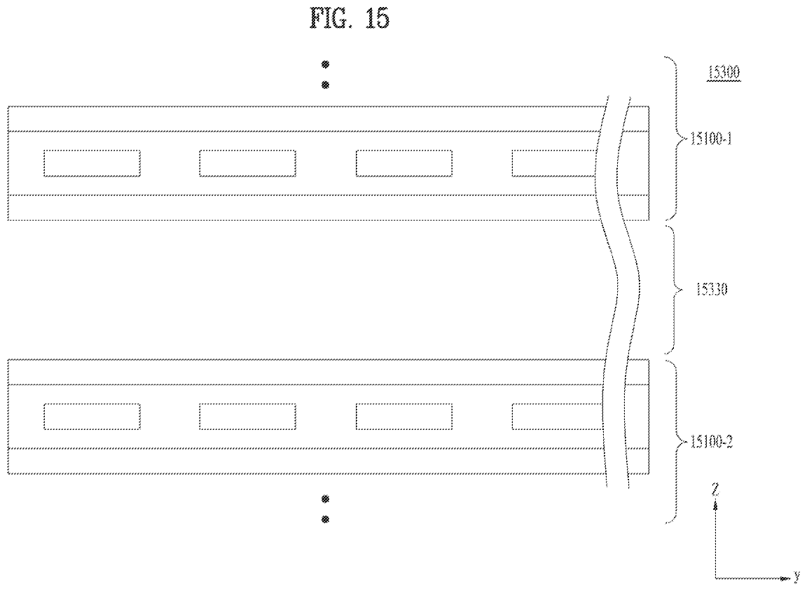

FIG. 15 is a stack-type busbar according to embodiments.

A stack-type busbar 15300 (for example, the stack-type busbar as described in FIGS. 10 to 14) according to embodiments may include one or more layers. A layer according to embodiments refers to a stacking unit of a stack-type busbar, and one layer may include one or more FFCs (for example, FFCs as described in FIGS. 1 to 14). Further, the layer according to the embodiments may include a hollow tube, a conductor, and another type of an object other than the FFC for efficient heat dissipation of the stack-type busbar.

FIG. 15 shows a stack-type busbar 15300 composed of three layers, that is, a first layer 15100-1, a second layer 15330 and a third layer 15100-2.

Each of the first layer 15100-1 and the third layer 15100-2 according to embodiments may include one FFC as shown in FIG. 15. The first layer 15100-1 or the third layer 15100-2 according to the embodiments includes, for example, any one of the first FFC, the second FFC, and the third FFC as described in FIGS. 12 to 14. In addition, each of the first layer 15100-1 and the third layer 15100-2 may include at least two or more FFCs. For example, the first layer 15100-1 or the third layer 15100-2 according to the embodiments may include the stacked FFCs (for example, the stack-type busbar) as described in FIGS. 12 to 14. The first layer 15100-1 according to embodiments may be disposed above the third layer 15100-2. That is, as shown in the drawing, the first layer 15100-1 is disposed above the third layer 15100-2 along the z-axis.

The second layer 15330 according to the embodiments may be disposed between the first layer 15100-1 and the third layer 15100-2. That is, along the z-axis, the first layer 15100-1 may be disposed on the second layer 15330 and the second layer 15330 may be disposed on the third layer 15100-2.

Since each of the first layer 15100-1 and the third layer 15100-2 includes the FFCs as described in FIGS. 1 to 14, efficient heat dissipation is possible even if they are stacked to be adjacent to each other. Further, when the first layer 15100-1 and the third layer 15100-2 are stacked to have a spacing therebetween, the stack-type busbar 15300 including the first layer 15100-1 and the third layer 15100-2 may dissipate heat more efficiently. Therefore, the stack-type busbar 15300 according to the embodiments includes the second layer 15330. The second layer 15330 according to the embodiments may have a thickness greater than or equal to a preset value (for example, a thickness of one FFC) for heat dissipation. That is, the spacing between the first layer 15100-1 and the third layer 15100-2 due to the presence of the second layer 15330 therebetween may be greater than or equal to a preset value. The second layer 15330 according to the embodiments may include a hollow tube, a conductor, or another type of an object other than the FFC for efficient heat dissipation of the stack-type busbar. Thus, heat generated from the plurality of FFCs (for example, the first layer 15100-1 and the third layer 15100-2) may be discharged to the outside through the second layer. That is, due to the spacing between the first layer 15100-1 and the third layer 15100-2, heat generated from the plurality of FFCs may be discharged to the outside.

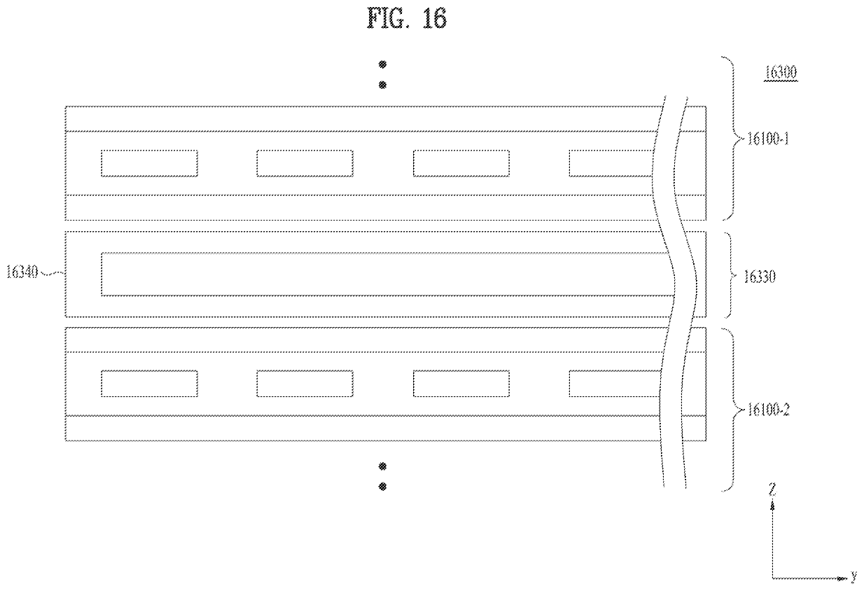

FIG. 16 is a stack-type busbar according to embodiments.

A stack-type busbar 16300 (for example, the stack-type busbar as described in FIGS. 10 to 15) according to the embodiments may include one or more layers (for example, the layer as described in FIG. 15). FIG. 16 shows the stack-type busbar 16300 composed of three layers, namely, a first layer 16100-1 (for example, the first layer 15100-1 as described in FIG. 15, a second layer 16330 (for example, the second layer 15330 as described in FIG. 15), and a third layer 16100-2 (for example, the third layer 15100-2 described in FIG. 15).

The first layer 16100-1 and the third layer 16100-2 shown in FIG. 16 are the same as the first layer 15100-1 and the third layer 15100-2 as described in FIG. 15, respectively. Thus, detailed descriptions thereof are omitted.

The second layer 16330 according to the embodiments may include a hollow tube 16340. FIG. 16 shows one hollow tube 16340. However, the disclosure is not limited thereto. The hollow tube 16340 according to the embodiments may include one or more hollow tubes. The hollow tube 16340 according to the embodiments may be disposed to be fitted into between the first layer 16100-1 and the third layer 16100-2. That is, the hollow tube 16340 according to the embodiments is disposed between the FFC of the first layer 16100-1 and the FFC of the third layer 16100-2. The FFC of the first layer 16100-1 adjacent to the hollow tube 16340 according to embodiments may be a FFC disposed at a bottom of the first layer 16100-1 along the z-axis. The FFC of the third layer 16100-2 adjacent to the hollow tube 16340 according to the embodiments may be a FFC disposed at a top of the third layer 16100-2 along a z-axis. The hollow tube 16340 according to the embodiments may dissipate heat discharged from the plurality of FFCs included in each of the first layer 16100-1 and the third layer 16100-2 or the stacked FFCs adjacent to the hollow tube 16340 to the outside. It may be difficult to dissipate heat generated from the plurality of FFCs only using air at room temperature located inside the hollow tube 16340 according to embodiments. In this case, heat may be released by flowing a fluid such as cooled air or water into the hollow tube 16340 according to the embodiments.

A cross-sectional shape of the hollow tube 16340 according to the embodiments may be a quadrangular shape (hereinafter, referred to as a “rectangular hollow tube”). However, the present disclosure is not limited thereto. The cross-sectional shape of the hollow tube 16340 may be a polygonal shape such as a triangle or a pentagon. The rectangular hollow tube 16340 may be embodied as a single large hollow tube 16340, as shown in FIG. 16. However, the disclosure is not limited thereto. Although not shown, the rectangular hollow tube 16340 may be embodied as a plurality of small rectangular hollow tubes.

The hollow tube 16340 according to the embodiments may be made of a conductor. The stack-type busbar 16300 including the hollow tube 16340 according to the embodiments may supply high power. Specifically, the hollow tube 16340 made of the conductor increases a percentage of a conductor included in the stack-type busbar 16300 according to the embodiments, thereby supplying greater power.

The hollow tube 16340 according to the embodiments may be made of an insulator. When the hollow tube 16340 according to the embodiments itself has an insulating effect, it is possible to suppress generation of an electric force between the FFC of the first layer 16100-1 and the FFC of the third layer 16100-2. Therefore, the hollow tube 16340 may suppress an attracting force between the FFC of the first layer 16100-1 and the FFC of the third layer 16100-2 via the electric force, such that a spacing between the first layer 16100-1 and the third layer 16100-2 may be further widened. Thus, the stack-type busbar 16300 including the hollow tube 16340 according to embodiments may more effectively reduce the heat existing in the stack-type busbar 16300.

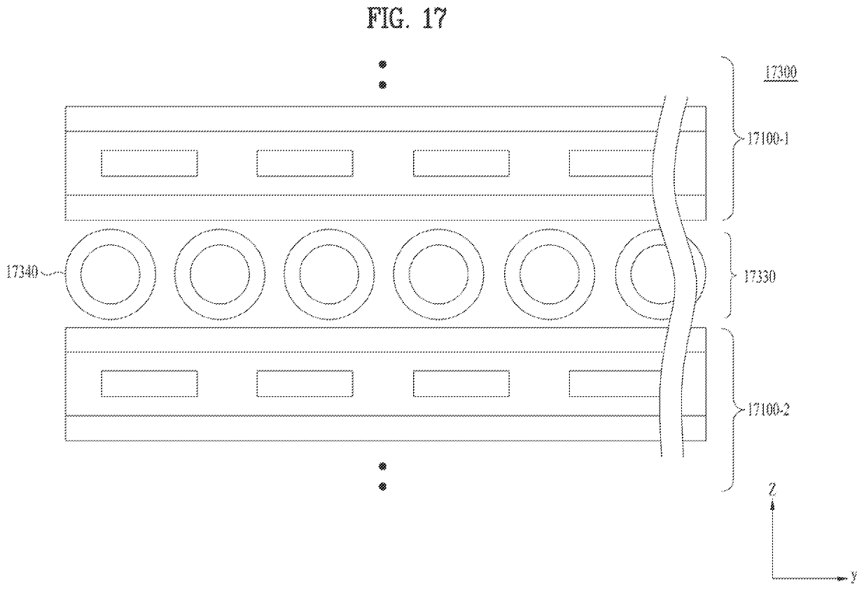

FIG. 17 is a stack-type busbar according to embodiments.

A stack-type busbar 17300 (for example, the stack-type busbar as described in FIGS. 10 to 16) according to the embodiments may include one or more layers (for example, the layer described in FIG. 15). FIG. 17 shows the stack-type busbar 17300 composed of three layers, namely, a first layer 17100-1 (for example, the first layer 15100-1 as described in FIG. 15, a second layer 17330 (for example, the second layer 15330 as described in FIG. 15), and a third layer 17100-2 (for example, the third layer 15100-2 described in FIG. 15).

The first layer 17100-1 and the third layer 17100-2 shown in FIG. 17 are the same as the first layer 15100-1 and the third layer 15100-2 as described in FIG. 15, respectively. Thus, detailed descriptions thereof are omitted.

The second layer 17330 according to the embodiments may include at least one hollow tube 17340. FIG. 17 shows a plurality of hollow tubes 17340. However, the disclosure is not limited thereto. In another example, the second layer 17330 according to the embodiments may include a single hollow tube 17340. The hollow tubes 17340 according to the embodiments may be disposed to be fitted into between the first layer 17100-1 and the third layer 17100-2. That is, the hollow tubes 17340 according to the embodiments is disposed between the FFC of the first layer 17100-1 and the FFC of the third layer 17100-2. The FFC of the first layer 17100-1 adjacent to the hollow tubes 17340 according to embodiments may be a FFC disposed at a bottom of the first layer 17100-1 along the z-axis. The FFC of the third layer 17100-2 adjacent to the hollow tubes 17340 according to the embodiments may be a FFC disposed at a top of the third layer 17100-2 along a z-axis. The hollow tubes 17340 according to the embodiments may dissipate heat discharged from the plurality of FFCs included in each of the first layer 17100-1 and the third layer 17100-2 or the stacked FFCs adjacent to the hollow tube 17340 to the outside. It may be difficult to dissipate heat generated from the plurality of FFCs only using air at room temperature located inside the hollow tubes 17340 according to embodiments. In this case, heat may be released by flowing a fluid such as cooled air or water into the hollow tubes 17340 according to the embodiments.

A cross-sectional shape of each of the hollow tubes 17340 according to the embodiments may be a circular shape (hereinafter, referred to as a “circular hollow tube”). However, the present disclosure is not limited thereto. The cross-sectional shape of the hollow tube 17340 may be a polygonal shape such as a triangle or a pentagon. The hollow tube 17340 may be embodied as an array of the plurality of small circular hollow tubes 17340 as shown in FIG. 17. However, the disclosure is not limited thereto. Although not shown, the hollow tube 17340 may be embodied as a single large circular hollow tube 17340

The hollow tube 17340 according to the embodiments may be made of a conductor. The stack-type busbar 17300 including the hollow tube 17340 according to the embodiments may supply high power. Specifically, the hollow tube 17340 made of the conductor increases a percentage of a conductor included in the stack-type busbar 17300 according to the embodiments, thereby supplying greater power.

The hollow tube 17340 according to the embodiments may be made of an insulator. When the hollow tube 17340 according to the embodiments itself has an insulating effect, it is possible to suppress generation of an electric force between the FFC of the first layer 17100-1 and the FFC of the third layer 17100-2. Therefore, the hollow tube 17340 may suppress an attracting force between the FFC of the first layer 17100-1 and the FFC of the third layer 17100-2 via the electric force, such that a spacing between the first layer 17100-1 and the third layer 17100-2 may be further widened. Thus, the stack-type busbar 17300 including the hollow tube 17340 according to embodiments may more effectively reduce the heat existing in the stack-type busbar 17300

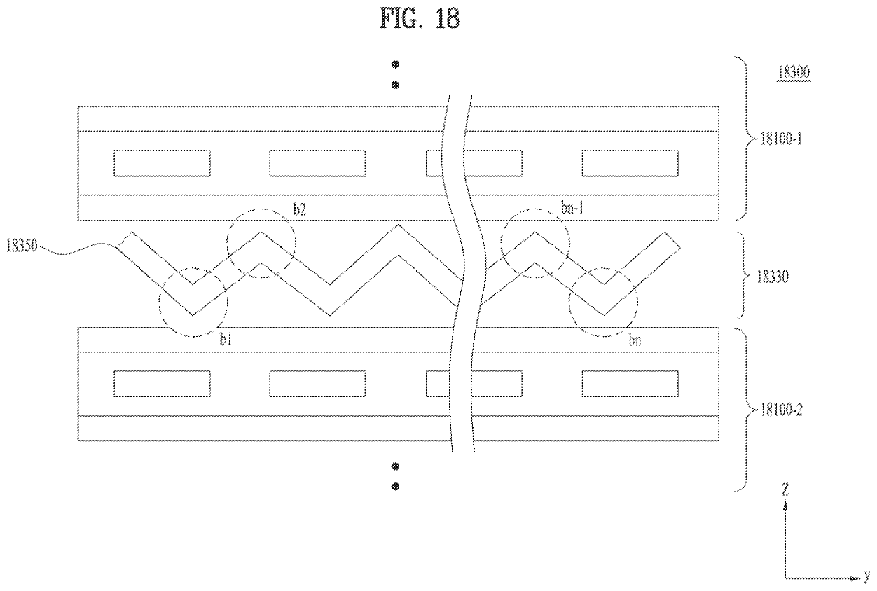

FIG. 18 is a stack-type busbar according to embodiments.

A stack-type busbar 18300 (for example, the stack-type busbar as described in FIGS. 10 to 17) according to embodiments may include one or more layers (for example, the layer described in FIG. 15). FIG. 18 shows the stack-type busbar 18300 composed of three layers, namely, a first layer 18100-1 (for example, the first layer 15100-1 as described in FIG. 15, a second layer 18330 (for example, the second layer 15330 as described in FIG. 15), and a third layer 18100-2 (for example, the third layer 15100-2 described in FIG. 15).

The first layer 18100-1 and the third layer 18100-2 shown in FIG. 18 are the same as the first layer 15100-1 and the third layer 15100-2 as described in FIG. 15, respectively. Thus, detailed descriptions thereof are omitted.

The second layer 18330 according to embodiments may include a bridge 18350. FIG. 18 shows one bridge (18350). However, the disclosure is not limited thereto. In another example, the bridge 18350 according to embodiments may include one or more bridges. The bridge 18350 according to embodiments may be disposed to be sandwiched between the first layer 18100-1 and the third layer 18100-2. That is, the bridge 18350 according to the embodiments is disposed between the FFC of the first layer 18100-1 and the FFC of the third layer 18100-2. The FFC of the first layer 18100-1 adjacent to the bridge 18350 according to embodiments may be a FFC disposed at a bottom of the first layer 18100-1 along the z-axis. The FFC of the third layer 18100-2 adjacent to the bridge 18350 according to the embodiments may be a FFC disposed at a top of the third layer 18100-2 along a z-axis. The bridge 18350 according to the embodiments may increase a spacing between the FFC of the first layer 18100-1 and the FFC of the third layer 18100-2. Specifically, the bridge 18350 according to the embodiments may support the FFC of the first layer 18100-1 and the FFC of the third layer 18100-2 so that the distance between the FFC of the first layer 18100-2 is equal to or greater than a preset distance. The bridge 18350 according to the embodiments may dissipate heat discharged from the plurality of FFCs included in each of the first layer 18100-1 and the third layer 18100-2 or the stacked FFCs adjacent to the bridge 18350 to the outside.

As shown in FIG. 18, the bridge 18350 according to the embodiments may have n bent portions b1, b2, . . . bn−1, bn (hereinafter, collectively referred to as a bent portion b). The number of bent portions b included in the bridge 18350 according to embodiments may vary depending on a purpose and a size of the stack-type busbar 18300. The bridge 18350 according to the embodiments may maintain a vertical dimension of the second layer 18300 at a predetermined size or greater using the bent portion.

The bridge 18350 according to the embodiments may be made of a conductor. The stack-type busbar 18300 including the bridge 18350 according to the embodiments may supply high power. Specifically, the bridge 18350 made of the conductor increases a percentage of a conductor included in the stack-type busbar 18300 according to the embodiments, thereby supplying greater power.

The bridge 18350 according to the embodiments may be made of an insulator. When the bridge 18350 according to the embodiments itself has an insulating effect, it is possible to suppress generation of an electric force between the FFC of the first layer 18100-1 and the FFC of the third layer 18100-2. Therefore, the bridge 18350 may suppress an attracting force between the FFC of the first layer 18100-1 and the FFC of the third layer 18100-2 via the electric force, such that a spacing between the first layer 18100-1 and the third layer 18100-2 may be further widened. Thus, the stack-type busbar 18300 including the bridge 18350 according to embodiments may more effectively reduce the heat existing in the stack-type busbar 18300.

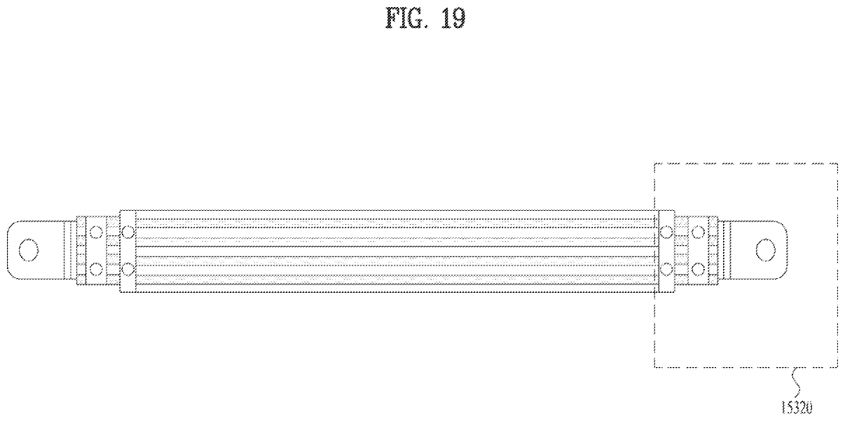

FIG. 19 is a stack-type busbar according to embodiments.

The stack-type busbar (for example, the stack-type busbar as described above with reference to FIG. 10 to FIG. 18) including one or more FFCs according to embodiments (for example, the FFCs as described above with reference to FIG. 1 to FIG. 14) may include a main body (for example, the main body as described above with reference to FIG. 1 and FIG. 10) and a terminal (for example, the terminal as described above with reference to FIG. 1 and FIG. 10). Each of metal structures at both ends of an array of the metal structures (for example, the metal structures as described above with reference to FIGS. 2 to 18) in a horizontal direction extends outwardly of one of the two insulating coating layers in a horizontal direction. The outward extension is referred to as the terminal.

The terminal may be connected to a connector 19320 to connect other electronic components, electronic devices, or electric devices to the busbar. When the stack-type busbar according to the embodiments includes the plurality of FFCs, the connector 19320 may act to connect the FFCs to each other. That is, in the stack-type busbar according to the embodiments, the stacked FFCs are connected to each other via the connector 19320.

When an end of each of the metal structures at both ends of an array of the metal structures is exposed to the outside, a reinforcing film layer may be further disposed on an outer face of the insulating coating layer in order to keep both ends of the FFC flat and to easily couple the connector 19320 to each of both ends of the FFC. For example, when an end of each of the metal structures at both ends of an array of the metal structures is upwardly exposed to the outside, the reinforcing film layer may be disposed on a bottom face of the lower insulating coating layer. Alternatively, when an end of each of the metal structures at both ends of an array of the metal structures is downwardly exposed to the outside, the reinforcing film layer may be disposed on a top face of the upper insulating coating layer. Alternatively, when an end of the metal structure at one of both ends of an array of the metal structures is downwardly exposed to the outside and an end of the metal structure at the other of both ends of an array of the metal structures is upwardly exposed to the outside, one reinforcing film layer is placed on a top face of the upper insulating coating layer, and the other reinforcing film layer is placed on a bottom face of the lower insulating coating layer.

The stack-type busbar according to the embodiments may have a structure in which the plurality of FFCs manufactured via the laminating process according to the embodiments (for example, the laminating process as described above with reference to FIGS. 5 to 9) are vertically stacked.

The connector 19320 according to embodiments may connect the terminals of the plurality of FFCs to each other. Specifically, the connector 15320 may connect the exposed portion of the metal structure at each of both ends of the FFC to a terminal of another FFC. The connector 15320 may connect the terminals of the plurality of FFCs in a rivet manner, a bolt manner, a resistance fusing manner, a pressing manner, or a die casting manner. However, the disclosure is not limited thereto.

The stack-type busbar shown in FIG. 15 includes at least one of the stack structures in FIGS. 12 to 14. For example, the stack-type busbar according to the embodiments may include a combination of the stack structure of FIG. 12 and the stack structure of FIG. 13. Further, the stack-type busbar according to the embodiments may include a combination of the stack structure of FIG. 12 and the stack structure of FIG. 14. The stack-type busbar according to embodiments may include a combination of the stack structure of FIG. 13 and the stack structure of FIG. 14. The stack-type busbar according to embodiments may include a combination of the stack structures of FIGS. 12 and 13 and the stack structure of FIG. 14.

The stack-type busbar shown in FIG. 19 includes at least one of the stack structures of FIGS. 12 to 18. For example, the stack-type busbar according to embodiments may include combinations of at least two of the stack structures of FIGS. 12 to 18.

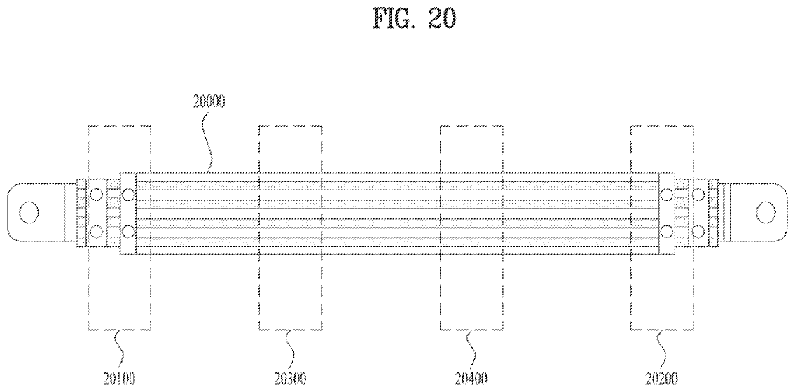

FIG. 20 is an example of a stack-type busbar 20000 according to embodiments.

The stack-type busbar 20000 as shown in FIG. 20 may include at least one FFC. One FFC included in the stack-type busbar 20000 according to the embodiments is the same as the FFC as described with reference to FIGS. 1 to 9, and thus detailed description thereof is omitted. Further, the stack-type busbar 20000 according to the embodiments may include at least one cross section as described with reference to FIGS. 10 to 18. Since the stack-type busbar 20000 according to the embodiments includes an organic resin film, the busbar 20000 may be flexibly bent within a certain angular range. When the stack-type busbar 20000 according to the embodiments is connected to various electronic devices, the busbar 20000 may be bent due to a limited installation space.

The stack-type busbar 20000 according to the embodiments may be connected to an electronic device while the stack-type busbar 20000 is bent or folded at a predefined region thereof during a manufacturing process thereof. In following descriptions, bending or folding the stack-type busbar is collectively referred to as ‘bending’. For example, the stack-type busbar 20000 may be fixed while a predefined region thereof is in a bent state. When necessary, at least one bent region may be defined on one face of the stack-type busbar for bending the stack-type busbar. The example in FIG. 20 shows the stack-type busbar 20000 including two terminals 20100 and 20200 and two bent regions 20300 and 20400.

In embodiments, at least one bent region (for example, bent regions 20300 and 20400 in FIG. 20) may be defined between the terminals respectively located at both ends of the stack-type busbar (for example, the terminals 20100 and 20200 in FIG. 20). In FIG. 20, the bent regions 20300 and 20400 are respectively defined as two regions arranged along a length direction of the stack-type busbar. However, this is only an example. One or more bent regions 20300 and 20400 may be defined on the stack-type busbar 20000.

When the stacked busbar 20000 is bent, portions of the upper and lower insulating coating layers at the bent region overlap each other, so that a thickness of the bent portion of the stacked busbar 20000 is relatively larger than that of the remaining portion of the stack-type busbar 20000. Further, due to the rigidity and thickness of each of the insulating coating layers itself, the bending angle may be limited to a value within a certain angle range. Therefore, the stack-type busbar manufacturing method according to the embodiments may be intended to reduce the thickness of the bent portion and increase the flexibility of the bending angle.

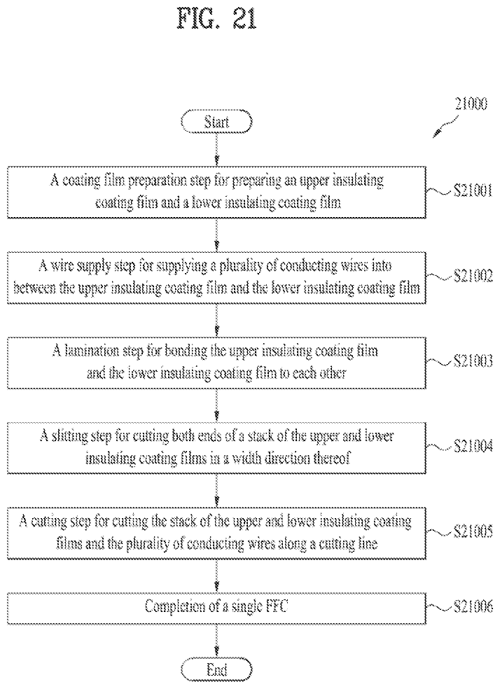

FIG. 21 is a flow chart 21000 showing a method for manufacturing a FFC according to embodiments.

FIG. 21 is a flowchart showing a method for manufacturing one FFC included in a stack-type busbar (for example, the stack-type busbar as described with reference to FIGS. 1 to 20) according to embodiments. The description about the FFC according to the embodiments is the same as that as described with reference to FIGS. 1 to 9, and thus the detailed description thereof is omitted. The FFC according to the embodiments may be formed using a process (roll-to-roll process) of disposing a plurality of conducting wires between two insulating coating films (for example, upper insulating coating film and lower insulating coating film), and then continuously bonding the plurality of conducting wires onto the two insulating coating films.

Hereinafter, a method for manufacturing the FFC according to the embodiments will be described in more detail.

First, the method may prepare an upper insulating coating film and a lower insulating coating film. In the embodiments of the coating film preparation step S21001, each of the upper insulating coating film and the lower insulating coating film may be made of an organic resin. More specifically, the organic resin may be any one of PI (Poly Imide), PET (Polyethylene Terephthalate), PEN (Poly Ethylene Napthalene), or PCT (Polycyclohexylenedimethylene Teraphthlate). The coating film preparation step S21001 aligns the upper insulating coating film and the lower insulating coating film with each other, and defines a predefined region in at least one insulating coating film among the upper insulating coating film and the lower insulating coating film. In another example, the defined region may be subdivided into regions. Each subdivided region may be punctured.

The plurality of conducting wires are supplied between the upper and lower insulating coating films (wire supply step S21002). The plurality of conducting wires may correspond to the metal structures as described with reference to FIGS. 1 to 18 above. The wire supply step S21002 may be performed simultaneously with the coating film preparation step S21001, or may be performed sequentially after the coating film preparation step. In the wire supply step S21002, the plurality of conducting wires may be continuously supplied between the upper and lower insulating coating films such that the plurality of conducting wires may be arranged in parallel with each other and spaced from each other by a constant spacing in a width direction of each of the insulating coating films. In embodiments, each of the conducting wire may include any one of iron (Fe), sludge metal, and aluminum (Al), and have a thickness of 0.2 mm to 0.5 mm and a width of 0.05 mm to 0.15 mm. In the wire supply step S21002, the upper insulating coating film, the plurality of conducting wires, and the lower insulating coating film may be sequentially and vertically stacked and then the stack may proceed toward a lamination process.

While the upper and lower insulating coating films pass between opposing pressure rollers, the upper and lower insulating coating films may be laminated. In the embodiments of a lamination step S21003, each of the upper and lower insulating coating films may further include a primer, and an adhesive while the primer is interposed between the adhesive and the primer. When the lamination step S21003 is performed, the upper and lower insulating coating films travel in a state in which the upper adhesive of the upper insulating coating film and the lower adhesive of the lower insulating coating film are in contact with each other. While the plurality of conducting wires are continuously fed between the two adhesives, the plurality of conducting wires may travel together with the upper and lower insulating coating films.

More specifically, the lamination step S21003 may further include at least one bonding step at different conditions. In embodiments, the lamination step S21003 may include a first lamination step and a second lamination step.

In the first lamination step, the laminated coating films pass between a pair of first heating rollers, while heat of a temperature within a range of 100° C. to 110° C. and a pressure in a range of 1 kgf/cm² to 3 kgf/cm² are applied to the upper insulating coating film or the lower insulating coating film. Since in the first lamination process, the plurality of conducting wires are pressed against the upper and lower insulating coating films while maintaining the alignment of the plurality of conducting wires, heat of a relatively low temperature and low pressure may be applied thereto.

In the second lamination step, the upper and lower coating films as attached to each other pass between a pair of second heating rollers, while heat of a temperature within a range of 140° C. to 160° C. and a pressure in a range of 90 kgf/cm² to 110 kgf/cm² are applied to the upper insulating coating film or the lower insulating coating film.

In embodiments, the lamination step S21003 may further include a third lamination step. The third lamination step may include compressing a reinforcing film onto a predefined region of the upper insulating coating film or the lower insulating coating film. In the third lamination step, a reinforcing film is periodically supplied to the predefined region of each of the upper and lower coating film travelling in a stacked state, and the upper and lower coating films having the reinforcing film formed thereon pass between a pair of third heating plates, and thus the reinforcing film is thermally compressed to each of the upper and lower coating films using the heating plates. In embodiments, the third lamination step may be made at a temperature within the range of 110° C. to 130° C. and a pressure within the range of 1 kgf/cm² to 3 kgf/cm².

The upper and lower insulating coating films bonded to each other via the lamination step S21003 are subjected to a slitting process (slitting step S21004). In the slitting step S21004, both ends of the stack of the insulating coating films in the width direction thereof are cut along a slitting line (for example, the slitting line 9240 as shown in FIG. 9) defined in the upper or lower insulating coating film. After the slitting process is performed, the insulating coating film has a width smaller than that of the exposure window 9150 as shown in FIG. 9.

The upper and lower insulating coating films and the conducting wires are cut along a cutting line defined on the upper or lower insulating coating film which has been subjected to the slitting process. In the embodiments of the cutting step S21005, the cutting line (for example, the cutting line 9230 as shown in FIG. 9) may be formed in the width direction of the upper or lower insulating coating film and on the exposure window. When the cutting line is formed across the reinforcing film, the reinforcing film may be cut in the cutting step S21005.

In the cutting step S21005, one FFC having a predetermined length is completed (S21006). The cut stack of the upper insulating coating film and the lower insulating coating film may correspond to the stack of the upper and lower insulating coating layers as described with reference to FIGS. 1 to 18.

In embodiments, the coating film preparation step S21001 may further include an ultraviolet based pre-treatment step. In the ultraviolet based pre-treatment step, before the primer and the adhesive are adhered to each of the upper and lower insulating coating films, the upper or lower insulating coating film may be irradiated with ultraviolet rays. The irradiated ultraviolet rays may have a wavelength in a range of 170 nm to 180 nm.

In embodiments, after the UV based pre-treatment step of the coating film preparation step S21001, the coating film preparation step S21001 may further include a step of bonding the primer and the adhesive to each of the upper and lower insulating coating films as irradiated with UV light

The ultraviolet based pre-treated film has superior dimensional stability at high temperature than that of a non UV-based pre-treated film. Therefore, when the insulating coating film is pre-treated with ultraviolet rays, deformation such as distortion, shrinkage, etc. thereof may be prevented during the lamination process. Further, the UV pre-treated film has better adhesion than that of the non UV-based pre-treated film. Therefore, when the insulating coating film is pre-treated with ultraviolet rays, the adhesive strength between each of the upper and lower insulating coating film and the adhesive, and between the upper and lower insulating coating films may be enhanced.

In embodiments, the coating film preparation step S21001 may further include a step (perforation step) of defining a predefined region on the upper or lower insulating coating film and perforating the predefined region of the stack of the upper and lower coating films. This perforated region may refer to an opening. Hereinafter, the perforation step will be described in detail.

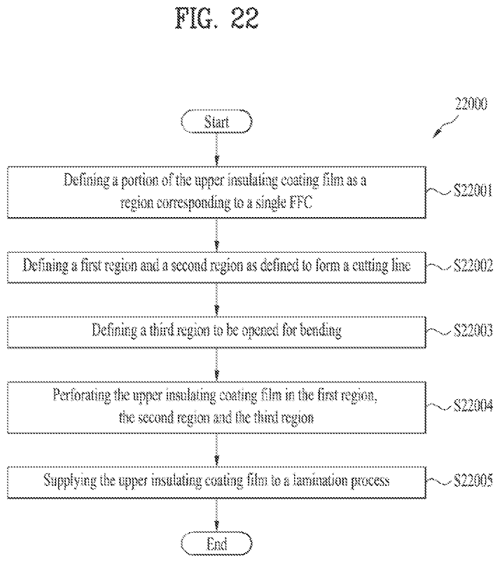

FIG. 22 is a flow chart 22000 showing a method for manufacturing a FFC according to embodiments.

As described with reference to FIG. 21, the coating film preparation step S21001 according to the embodiments aligns the upper insulating coating film and the lower insulating coating film with each other and defines the predefined region in at least one insulating coating film of the upper insulating coating film and the lower insulating coating film. The defined region may be subdivided into regions, and then each subdivided region is punctured. The flowchart 2200 in FIG. 22 shows the region definition step and the perforation step included in the coating film preparation step S21001 in FIG. 21 of the flowchart 21000 as described with reference to FIG. 21.

A portion of the upper insulating coating film is defined as a region corresponding to one FFC S22001. Since the upper insulating coating film is continuously supplied to a manufacturing system while being wound on a roll, a region corresponding to a length and/or a width of one FFC is defined. The length of the region defined in step S22001 corresponds to a length of the finally completed FFC. For example, the length of the defined region is larger than or equal to the length of the FFC. The width of the region defined in step S22001 corresponds to a width of the finally completed FFC. For example, the width of the region defined in step S22001 is equal to or larger than a width of the finally completed FFC. The length and the width of the region as defined according to the embodiments may vary according to the length and the width of the finally completed FFC. In other words, as it is possible to flexibly define the region required to produce the FFC, it is possible to manufacture the FFC without wasting resources. The region definition step S22001 according to the embodiments is applied in the same way to the lower insulating coating film.

The region as defined in step S22001 may be subdivided into at least two subdivided regions. The subdivided region may be later used for a specific process in the manufacturing process. For example, the subdivided region according to the embodiments may include a first region and a second region for forming a cutting line, and a third region for bending. Due to the space constraint, the FFC may be bent and then may be connected to the electronic device. The third region defined in step S22001 may correspond to a portion where the FFC is bent. Accordingly, the third region according to the embodiments may reduce a thickness of the bent portion of the FFC and thus increase the flexibility of the bending angle.

The region as defined in step S22001 may be subdivided into the first region and the second region as defined to form the cutting line (S22002). The cutting line refers to a reference line for cutting the stack of the insulating coating films and the conducting wires in the cutting step S21005 in FIG. 21. One FFC is completed by cutting the stack of the insulating coating films and the conducting wires along the defined cutting line. The cutting line according to the embodiments may be formed on a portion of at least one of the first region and the second region and across the upper insulating coating film in the width direction thereof. The first region and the second region according to the embodiments may be respectively located at both ends in the longitudinal direction of the predetermined region defined in step S22001. The first region and the second region according to the embodiments may be spaced from each other by a certain spacing and may be defined on one face of the upper insulating coating film as continuously supplied to the manufacturing system.

The region as defined in step S22001 may be further subdivided to define the third region to be opened for bending (S22003). The third region according to the embodiments may be defined on each of the adjacent upper insulating coating films which are separately cut along the cutting line. That is, the third region may be located between the first region and the second region where first and second cutting lines are formed, respectively. The third region according to embodiments may be defined between adjacent cutting lines. The third region may not be cut in the cutting step but may be defined on each of the adjacent upper insulating coating films which are separately cut along one cutting line.

The upper insulating coating film may be perforated in the first region, the second region, and the third region thereof as defined in step S22001 (S22004). In S22004 step, the perforation scheme may include either physical perforation using a press machine or the like and chemical perforation using a chemical. According to the perforation step S22004, the first region, the second region, and the third region of the upper insulating coating film may be perforated into an empty space or an opening.

S22002 step, S22003 step and S22004 step according to the embodiments may be equally applied to the lower insulating coating film. The lower insulating coating film according to the embodiments is disposed under the upper insulating coating film in the z-axis direction as described with reference to FIG. 2. Accordingly, the lower insulating coating film according to the embodiments includes regions opposite to (or corresponding to) the first region and the second region, and the corresponding regions thereof are perforated. Further, the lower insulating coating film according to the embodiments may include a region opposite to (or corresponding to) the third region, and the corresponding region thereof is perforated.

At least one of steps S22001, S22002, S22003, and S22004 according to the embodiments may be performed simultaneously. For example, step S22001, step S22002 and step S22003 may be performed simultaneously. Alternatively, step S22001, step S22002, step S22003, and step S22004 may be performed simultaneously. Alternatively, step S22002, step S22003, and step S22004 may be performed simultaneously. Alternatively, step S22001, step S22002, step S22003, and step S22004 according to the embodiments may be performed in a modified order different from the order as shown in the drawings. For example, an order in which step S22002 and step S22003 are executed may be changed.

The upper insulating coating film is supplied to the lamination process (S22005).

As described with reference to FIG. 21, prior to the lamination process, the plurality of conducting wires are supplied between the upper insulating coating film and the lower insulating coating film (step S21002 as described with reference to FIG. 21). Further, in the lamination process, the upper insulating coating film is bonded to the lower insulating coating film (step S21003 as described with reference to FIG. 21). As described above, the upper insulating coating film includes the perforated first region, the perforated second region, and the perforated third region. When the insulating coating film is perforated in the first region, the second region and the third region thereof, the plurality of conducting wires as supplied between the upper insulating coating film and the lower insulating coating film may be exposed to the outside though the perforated regions (for example, through the perforated regions formed in the upper insulating coating film and/or the lower insulating coating film).

Among the perforated regions, the regions for cutting (for example, the first region, and the second region) is relatively thinner than other regions that are not perforated. Thus, the film may be easily cut in the first region, and the second region. Further, due to reduction of the thickness in the region for bending (for example, the third region) among the perforated regions, the FFC may be easily bent in the third region.

The lamination process according to the embodiments further includes the third lamination step. In the third lamination step according to the embodiments, the reinforcing film is pressed onto a region opposite to the first region or the second region. Since cutting lines are respectively formed in the first region and the second region, the first and second regions may respectively correspond to both ends of one FFC in the length direction thereof. When the reinforcing film is compressed on the upper or lower coating film, both end portions of the FFC are kept flat to maintain the shape of the FFC, and, in this state, connectors (or connection terminals) may be easily connected to both ends of the FFC, respectively.

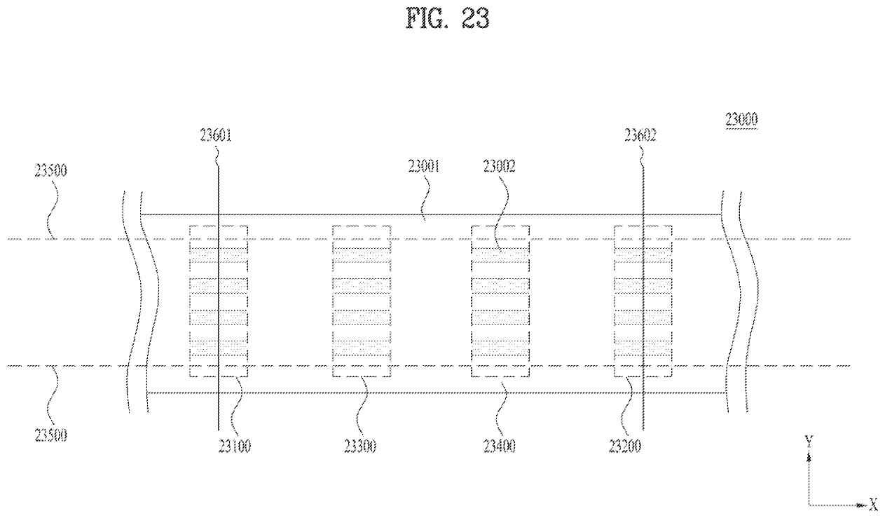

FIG. 23 is a top view of a film type cable according to embodiments.

The film type cable 23000 according to the embodiments refers to an entire combination of the insulating coating films 23001 and the plurality of conducting wires 23002 as bonded to each other. The insulating coating films 23001 according to the embodiments includes the upper insulating coating film and the lower insulating coating film as described with reference to FIGS. 21 to 22. The film type cable 23000 according to the embodiments is completed after the coating film preparation step (for example, S21000 step and S2100 step in FIG. 21) and the lamination step (for example, S21003 step in FIG. 21). As described above, the insulating coating films 23001 and the plurality of conducting wires 23002 may be bonded to each other via the coating film preparation step (for example, S21001 step and S21002 step in FIG. 21) and the lamination step (for example, S21003 step in FIG. 21). The plurality of conducting wires 23002 may be bonded to and fixedly disposed between the upper and lower insulating coating films 23001. The film type cable 23000 according to the embodiments may be provided via following processes (for example, the slitting step S21004 and the cutting step S21005).

FIG. 23 shows a top view of the film type cable 23000. The top face of the film type cable 23000 according to the embodiments may refer to an outer face of a top layer (for example, the upper insulating coating film) in the z-axis (for example, z-axis as shown in FIG. 3)) of the FFC (FFC as described with reference to FIGS. 1 to 9). As shown in FIG. 23, the top face of the film type cable 23000 includes a first region 23100, a second region 23200, and at least one third region (in this case, third regions 23300 and 23400). As described with reference to FIG. 21, in the coating film preparation step (for example, S21001 in FIG. 21) according to the embodiments, the first region 23100 and the second region 23200 for forming the cutting lines 23601 and 23602 respectively may be defined on the insulating coating film 23001, and the third regions 23300 and 23400 for bending may be defined thereon. The at least one third region (in this case, the regions 23300 and 23400) according to embodiments is positioned between the first region 23100 and the second region 23200. FIG. 23 shows an example in which the two third regions 23300 and 234000 are formed between the first region 23100 and the second region 23200. However, the disclosure is not limited thereto.

The insulating coating film is perforated in the first region 23100, the second region 23200, and the third regions 23300 and 23400 according to the embodiments, such that the insulating coating film has openings corresponding to the perforated regions. The film type cable 23000 having the perforated regions defined therein may continuously travel in one direction (e.g., a left-to-right direction or a right-to-left direction of the drawing in the X-axis of FIG. 23) toward a next process. Accordingly, the plurality of conducting wires 23002 disposed between the upper and lower insulating coating films 23001 may be exposed to the outside through the empty space or the opening. Although not as shown in the drawing, a bottom face of the film type cable 23000 (for example, an outer face of the lowermost layer in the z-axis direction of the FFC, or an outer face of the lower insulating coating film) may have at least one perforated region corresponding to at least one of the first region, the second region, and the third region.

In embodiments, the insulating coating film 23001 may have the slitting line formed thereon which will be used in a subsequent process. Two dotted lines 23500 as shown in the FIG. 23 represent two slitting lines. Although the two slitting lines are as shown in the drawing, at least one slitting line may be formed. That is, the number of slitting lines is not limited to the example as shown in the drawing.

Each slitting line 23500 extends in parallel to each of both ends of the insulating coating film 23001 in the width direction thereof. In the slitting step S21004 in FIG. 21, at least one widthwise end portion of the upper and lower insulating coating films 23001 as bonded to each other is cut along the slitting line 23500. Therefore, when going through the slitting step S21004 in FIG. 21, the width of the film type cable 23000 becomes narrower than the width thereof before the slitting step.

A spacing between at least two slitting lines 23500 according to the embodiments is equal to or smaller than the width of each of the first region 23100, the second region 23200, or the third regions 23300 and 23400. After going through the slitting step S21004 in FIG. 21, the width of the film type cable 23000 is smaller than the width of each of the first region 23100, the second region 23200, or the third regions 23300 and 23400. Thus, in each of the first region 23100, the second region 23200, or the third regions 23300 and 23400, the coating films 23001 are completely removed.

In embodiments, on the insulating coating films 23001, the cutting line to be used in a subsequent process may be formed. Two solid lines 23601 and 23602 as shown in the drawing represent two cutting lines. Although two cutting lines are as shown in the drawing, at least one cutting line may be formed. Thus, the number of cutting lines is not limited to the example as shown in the drawing. The at least one cutting line extends along the width direction of the insulating coating films 23001 (for example, the Y-axis direction in FIG. 23) on the first region 23100 and the second region 23200.

FIG. 23 shows an example in which the two cutting lines 23601 and 23602 extend along the width direction of the insulating coating films 23001 on the first region 23100 and the second region 23200 of the insulating coating films 23001, respectively. The disclosure is not limited thereto.

In the cutting step S21005 in FIG. 21, the insulating coating films 23001 and the conducting wires 23002 are cut along the cutting lines 23601 and 23602. As described with reference to FIG. 21, one FFC is formed via the cutting step S21005 in FIG. 21. A spacing between one cutting line (for example, the cutting line 23601) and the adjacent cutting line (for example, the cutting line 23602) according to the embodiments may correspond to a length of one FFC as described with reference to FIG. 21.

The third regions 23300 and 23400 according to the embodiments are formed between the two cutting lines 23601 and 23602 adjacent to each other. Accordingly, the completed FFC is easily bent in portions corresponding to the two third regions 23300 and 23400.

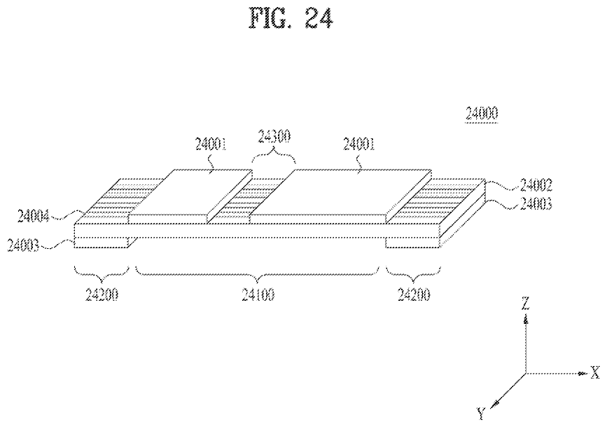

FIG. 24 is a perspective view of an FFC according to embodiments.

A FFC 24000 as shown in FIG. 24 includes a film type cable (for example, the film type cable 23000 as described with reference to FIG. 23) which has been subjected to the slitting and cutting steps (for example, S21004, and S21005) as described with reference to FIG. 21. The FFC 24000 capable of transmitting electrical signals or electrical energy according to the embodiments may include a film type main body 24100 extending in the longitudinal direction of the FFC, and each terminal 24200 disposed at each of both ends of the film type main body 24100 in the length direction thereof. The FFC 24000 according to the embodiments may include at least one of the FFC structures as described with reference to FIGS. 1 to 9 and FIGS. 21 to 23. Descriptions of configurations that overlap with those of FIGS. 1 to 9 and FIGS. 21 to 23 may refer to the above descriptions.

The film type main body 24100 according to the embodiments may include two insulating coating layers 24001 and 24002 as vertically arranged and made of an organic resin, multiple conducting wires 24004 as arranged in the width direction of the FFC and spaced apart from each other by a predetermined spacing and disposed between the two insulating coating layers 24001 and 24002, an adhesive provided between the two insulating coating layers 24001 and 24002 while surrounding the plurality of the conducting wires 24004 to fix the plurality of conducting wires 24004, and at least one opening 24300 formed by removing the insulating coating layer of the two insulating coating layers 24001 and 24002 in at least one predefined region.

The two insulating coating layers 24001 and 24002 may be formed by treating the upper insulating coating film and the lower insulating coating film (for example, the upper insulating coating film and the lower insulating coating film as described with reference to FIG. 21 to FIG. 23) via the treating process (for example, 21000 in FIG. 21). That is, the upper insulating coating layer 24001 positioned at the top in the z-axis direction is formed by treating the upper insulating coating film, and the lower insulating coating layer 24002 is formed by treating the lower insulating coating film.

The opening 24300 according to the embodiments corresponds to the bent portion of the FFC. The opening 24300 according to the embodiments corresponds to a perforated region for bending as defined in at least one of the upper insulating coating layer 24001 and the lower insulating coating layer 24002 as described with reference to FIGS. 21 to 23. As described with reference to FIGS. 21 to 23, at least one of the upper insulating coating layer 24001 and the lower insulating coating layer 24002 has a perforated region for bending defined therein (for example, the third regions 23300 and 23400 as described with reference to FIG. 23). As described with reference to FIGS. 22 to 23, the coating layer thickness in the perforated region for bending is relatively smaller than those of other regions that are not perforated. Thus, the FFC 24000 may be easily bent in this perforated region.

Only one opening 24300 is as shown in FIG. 24. However, the disclosure is not limited thereto. The opening 24300 according to embodiments includes at least one opening formed in the film type main body 24100. The process of forming the opening 24300 according to the embodiments is the same as a process including the steps S22003 and S22004 as described with reference to FIG. 22 in which the third region to opened for bending is defined and perforated. Thus, detailed description thereof is omitted.

The opening 24300 according to the embodiments may be defined in a top face (for example, an outer face of the upper insulating coating layer 24001) and/or a bottom face (for example, an outer face of the lower insulating coating layer 24002) of the FFC 24000 in the z-axis direction. The openings formed in the upper insulating coating layer 24001 and the openings formed in the lower insulating coating layer 24002 according to the embodiments may be aligned with each other in a line along the z axis. Predefined regions of the plurality of conducting wires 24004 according to the embodiments are exposed to the outside through the openings formed in the upper insulating coating layer 24001 and the openings formed in the lower insulating coating layer 24002. Accordingly, the FFC 24000 according to the embodiments has one bent region (or portion) corresponding to the opening formed in the upper insulating coating layer 24001 and the opening formed in the lower insulating coating layer 24002 as aligned with each other in a line along the z axis.

The openings formed in the upper insulating coating layer 24001 and the openings formed in the lower insulating coating layer 24002 according to the embodiments may not be aligned with each other in a line along the z axis. The FFC 24000 according to the embodiments may have two bent regions (or portions) respectively corresponding to a single opening formed in the upper insulating coating layer 24001 and a single opening formed in the lower insulating coating layer 24002.

Therefore, when an opening is formed in at least one of the upper insulating coating layer 24001 and the lower insulating coating layer 24002 included in the film type main body, the insulating coating layer is formed as a discontinuous layer. As shown in the drawing, the upper insulating coating layer 240010 is present in a discontinuous form due to the opening 24300 defined therein.

In embodiments, the film type main body 24100 may be achieved using: the first lamination process in which heat of a temperature within a range of 100° C. to 110° C. and a pressure within a range of 1 kgf/cm² to 3 kgf/cm² are applied to the at least one insulating coating film; and then the second lamination process immediately after the first lamination process in which heat of a temperature within a range of 140° C. to 160° C. and a pressure within a range of 90 kgf/cm² to 110 kgf/cm² are applied to the at least one insulating coating layer. Details on the first lamination and the second lamination refer to the details as described above in the lamination step S21003 of FIG. 21.

The material of the organic resin used for forming the two insulating coating layers 24001 and 24002 may be any one of PI (Poly Imide), PEN (Poly Ethylene Napthalene), or PCT (Polycyclohexylenedimethylene Teraphthlate).

The plurality of conducting wires 24004 included in the film type main body 24100 may include any one of iron (Fe), sludge metal, and aluminum (Al). Further, each of the plurality of conducting wires 24004 may have a thickness of 0.2 mm to 0.5 mm and a width of 0.05 mm to 0.15 mm.

The adhesive (not shown) included in the film type main body 24100 may include polyester.

The terminal 24200 may be formed in a predetermined region in each of both ends of the film type main body 24100. The predetermined region according to the embodiments may be a region corresponding to each of the first region and the second region as described with reference to FIGS. 21 to 23. That is, the film type cable (e.g., 23000 in FIG. 23) is cut along the cutting lines respectively defined in the first region and the second region. Thus, a least one portion of each of both ends of the film type cable (e.g., 23000 in FIG. 23 may be formed as the terminal 24200. As described with reference to FIGS. 21 to 23, a portion of the insulating coating film corresponding to each of the first region 23100 and the second region 23200 in which the cutting lines 23601 and 23602 are defined may be perforated to form an empty space or the opening. Thus, portions of conducting wires 24004 as exposed to the outside may act as the terminal 24200. Accordingly, the exposed portions of the conducting wires 24004 acting as the terminal 24200 may correspond to the metal clad portions as described above with reference to FIGS. 1 to 18.

In embodiments, the terminal 24200 may further include a reinforcing film 24003 connected to the film type main body 24100. The reinforcing film 24003 may be formed via the third lamination process in which heat of a temperature within a range of 110° C. to 130° C. and a pressure within a range of 1 kgf/cm² to 3 kgf/cm² are applied thereto. Details on the third lamination process may refer to the details as described in the lamination step S21003 of FIG. 21.

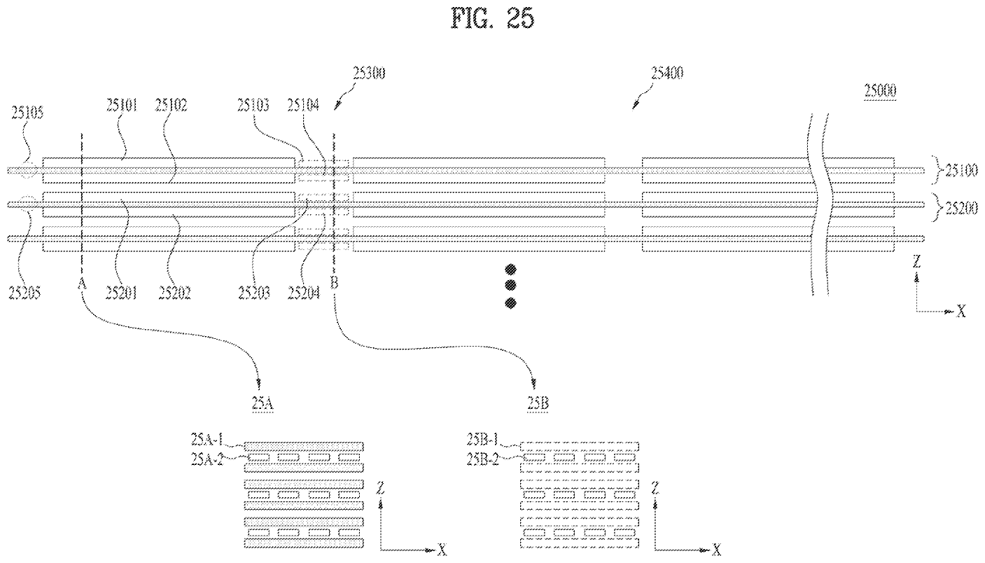

FIG. 25 is an example of a stack-type busbar according to embodiments.

FIG. 25 shows a stack-type busbar 25000 containing at least one FFC. The stack-type busbar 25000 as shown in FIG. 25 may include at least one of the stack-type structures of FIGS. 12 to 18. For example, the stack-type busbar 25000 according to the embodiments may include all of the stack-type structures of FIGS. 12 to 18. Each FFC included in the stack-type busbar 25000 according to the embodiments is the same as the FFC as described with reference to FIGS. 1 to 9 and FIGS. 21 to 24. Thus, the detailed description thereof is omitted.

As shown in FIG. 25, the stack-type busbar 25000 according to the embodiments may include a plurality of FFCs (for example, the first FFC 25100 and the second FFC 25200) extending in the first direction (for example, the x-axis direction of FIG. 25) and vertically stacking with each other in the second direction (e.g., the z-axis direction in FIG. 25). For example, the first FFC 25100 included in the plurality of FFCs is disposed adjacent to the second FFC 25200 in the z-axis direction. That is, a lower insulating coating layer 25102 of the first FFC 25100 is in contact with an upper insulating coating layer 25201 of the second FFC 25200. Alternatively, as in the structure of the stack-type busbar as described with reference to FIGS. 14 to 18, the FFCs may be spaced apart by a predetermined spacing and be vertically stacked one on top of the other.

At least one FFC among the plurality of FFCs according to embodiments may include at least one opening (for example, the opening 24300 as described with reference to FIG. 24). For example, the upper insulating coating layer and/or the lower insulating coating layer of the first FFC 25100 may include the at least one opening. For example, the upper insulating coating layer and/or the lower insulating coating layer of the second FFC 25200 may include the at least one opening. For efficient bending of the stack-type busbar 25000, the opening of the first FFC 25100 and the opening of the second FFC 25200 according to the embodiments may be aligned with each other along one line (dotted line B in FIG. 25) parallel to the direction (z-axis) in which the first FFC 25100 and the second FFC 25200 are stacked one on top of another. Accordingly, the stack-type busbar 25000 according to the embodiments includes at least one bent region (or portion) corresponding to at least one or more openings as aligned with each other in a line along the z-axis and stacked one on top of another. FIG. 25 shows an example of a stack-type busbar 25000 including two bent regions 25300 and 25400. However, the number of the bent regions is not limited to the above example. Further, the bending regions 25300 and 25400 of FIG. 25 may include openings formed in top and bottom faces of each of the plurality of FFCs. However, the number of the openings is not limited to the above example. The process for forming the opening of each FFC is the same as described with reference to FIGS. 22 to 24 (for example, the steps of defining and perforating the third regions S22003 and S22004 for bending as described with reference to FIG. 22). Thus, detailed description thereof is omitted.

FIG. 25 shows an example of a vertically open bending region 25300 formed when the openings formed in the upper insulating coating layer and the lower insulating coating layer of all FFCs are stacked and aligned with each other in a line along the z-axis.

The bent region 25300 as shown in the drawing includes a stack of a first opening 25103 and a second opening 25104 formed in the upper insulating coating layer 25101 and the lower insulating coating layer 25102 of the first FFC 25100, respectively, a third opening 25203 and a fourth opening 25204 formed in the upper insulating coating layer 25201 and the lower insulating coating layer 25102 of the second FFC 25200, respectively. As shown in the drawing, the first opening 25103 formed in the upper insulating coating layer 25101 of the first FFC 25100 and the second opening 25104 formed in the lower insulating coating layer 25102 thereof are vertically stacked and aligned with each other in a line along the z direction. The third opening 25203 formed in the upper insulating coating layer 25201 of the second FFC 25200 according to the embodiments and the fourth opening 25204 formed in the lower insulating coating layer 25202 thereof are vertically stacked and aligned with each other in a line along the z direction. Accordingly, the first opening 25103, the second opening 25104, the third opening 25203, and the fourth opening 25204 are vertically stacked and aligned with each other in a line along the z direction.

A lower left of FIG. 25 shows a cross section 25A of one portion of the stack-type busbar 25000 corresponding to a dotted line A. One portion of the stack-type busbar 25000 corresponding to the cross section 25A is free of the opening. As shown in the section 25A, the insulating coating layers 25A-1 of each FFC (for example, the first FFC 25100 or the second FFC 25200) and a plurality of conducting wires 25A-2 are stacked in the z-axis direction.

A lower right of FIG. 25 shows a cross section 25B of the bent region 25300 of the stack-type busbar 25000 corresponding to a dotted line B. As shown in the cross section 25B, a portion of the insulating coating layer 25B-1 (for example, the upper insulating coating layer 25103) corresponding to the opening of each FFC (for example, the first FFC 25100) is completely removed. Instead, only the plurality of conducting wires 25B-2 are stacked one on top of another in the z-axis direction. Accordingly, a thickness of the bent region 25300 of the stack-type busbar 25000 corresponding to the dotted line B is smaller than a thickness of the portion of the stack-type busbar 25000 corresponding to the dotted line A.

Since each of the bent regions 25300 and 25400 of the stacked busbar 25000 is relatively thinner than the remaining region of the stack-type busbar 25000, the thickness of the bent portion may be reduced and thus the flexibility of the bending angle may be increased

Table 3 below shows a thickness of the bent portion when the stack-type busbar is bent.

TABLE 3

| | | | Thickness |
|---|---|---|---|
| Type of busbar | Free of opening | With opening | difference |
| Thickness of bent | 19.50 mm | 12.19 mm | 7.31 mm |
| portion (before | | | |
| insertion of | | | |
| shrinkable tube) | | | |
| Thickness of bent | 14.21 mm | 8.89 mm | 5.32 mm |
| portion (after | | | |
| insertion of | | | |
| shrinkable tube) | | | |

[Table 3] compares the thickness of the bent portion when bending the stack-type busbar without the opening with the thickness of the bent portion of the stack-type busbar 25000 (for example, the stack-type busbar including opening) according to the embodiments. A first row of [Table 3] shows the thickness of the bent portion of the stack-type busbar that does not have an opening and the thickness of the bent portion of the stack-type busbar 25000 according to the embodiments before inserting the shrinkable tube. The stack-type busbar 25000 is bent at the portions 25300 and 25400. Before inserting the shrinkable tube, the thickness of the bent portion of the stack-type busbar 25000 according to the embodiments is reduced by 7.31 mm compared to the thickness of the bent portion of the stack-type busbar that does not have an opening. A second row of [Table 3] shows the thickness of the bent portion of the stack-type busbar that does not have an opening and the thickness of the bent portion of the stack-type busbar 25000 according to the embodiments after inserting the shrinkable tube. The stack-type busbar 25000 is bent at the portions 25300 and 25400. After inserting the shrinkable tube, the thickness of the bent portion of the stack-type busbar 25000 according to the embodiments is reduced by 5.32 mm compared to the thickness of the bent portion of the stack-type busbar that does not have an opening. Thus, the stack-type busbar 25000 according to the embodiments may easily change a shape thereof, the stack-type busbar 25000 according to the embodiments may be easily connected to an electronic device when an installation space is limited.

In embodiments, the stack-type busbar 25000 may further include the shrinkable tube (not shown) surrounding an outer face thereof. The shrinkable tube may apply a predetermined pressure from the outer surface of the stack-type busbar 25000 toward the inside thereof to reduce a volume or a thickness of the stack-type busbar 25000. In the above [Table 3], it may be seen that the thickness of the stack-type busbar 25000 including the shrinkable tube is reduced than that of the stack-type busbar 25000 without the shrinkable tube.

In embodiments, the stack-type busbar 25000 may further include a connection terminal (not shown) electrically connected to each of the terminals 25105 and 25205 of the FFC of each layer. The connection terminal may be embodied as the connector 19320 as described above with reference to FIG. 19. Therefore, the detailed description of the connection terminal may refer to the above description.

In embodiments, the stack-type busbar 25000 may further include an insulating tube (not shown) surrounding the outer surface of the stack-type busbar 25000. A thickness of the insulating tube may be equal to or larger than the thickness of the insulating coating layer of each FFC. The insulating tube may surround the outer surface of the stack-type busbar 25000, thereby to prevent the stack-type busbar 25000 from being short-circuited with other electronic devices and wires in an unintended region.

The FFC according to the embodiments has the insulating coating layer formed by laminating the PCT film, thereby to reduce the weight of the FFC, and improve the thermal emissivity of the FFC.

Further, the FFC according to the embodiments includes a metal structure made of not only copper but also various metal conductors such as sludge metal (for example, iron (Fe), so that the manufacturing cost thereof may be reduced.

Further, the FFC according to the embodiments includes the metal structure whose cross-sectional area is adjusted, such that the thermal resistance of the metal structure may be lowered. The FFC according to the embodiments may include the adhesive made of the material having high thermal emissivity to maintain the temperature of the FFC at a constant level.

Moreover, the stack-type busbar according to the embodiments has a stacked structure capable of improving heat dissipation efficiency even though the plurality of FFCs are vertically stacked.

Moreover, in the FFC or stack-type busbar according to the embodiments, the predefined region of the insulating film layer may be removed to define the opening, so that when the FFC or the stack-type busbar is bent, a thickness of a portion to be bent may be reduced, and thus flexibility of a bending angle may be increased.

The present disclosure as described above may be subjected to various substitutions, modifications, and changes within the scope of the present disclosure without departing from the technical spirit of the present disclosure by a person having ordinary knowledge in the technical field to which the present disclosure belongs. Thus, the disclosure is not limited to the accompanying drawings.

What is claimed is:

1. A method for manufacturing a flexible flat cable (FFC), the method comprising:
a coating film preparation step for preparing an upper insulating coating film and a lower insulating coating film, wherein each of the upper insulating coating film and the lower insulating coating film is made of an organic resin;
a wire supply step for supplying a plurality of conducting wires into between the upper insulating coating film and the lower insulating coating film;
a lamination step for bonding the upper insulating coating film and the lower insulating coating film to each other;
a slitting step for cutting both ends of a stack of the upper and lower insulating coating films in a width direction thereof; and
a cutting step for cutting the stack of the upper and lower insulating coating films and the plurality of conducting wires along a cutting line formed on the stack,
wherein the coating film preparation step further includes:
defining a portion of the upper insulating coating film as a region corresponding to a single FFC, wherein the region includes a first region and a second region for forming the cutting line, and a third region for bending; and
perforating the upper insulating coating film in the first region, the second region and the third region;
wherein the cutting line extends along a width direction of the upper insulating coating film and on at least one of the first region or the second region,
wherein the third region is contained in a single upper insulating coating film cut individually along the cutting line,
wherein each of the plurality of conducting wires include one of iron (Fe), sludge metal, and aluminum (Al), and has a thickness of 0.2 mm to 0.5 mm and a width of 0.05 mm to 0.15 mm.

2. The method of claim 1, wherein the coating film preparation step further includes perforating a region of the lower insulating coating film opposite to the first region or the second region.

3. The method of claim 1, wherein the coating film preparation step further includes perforating a region of the lower insulating coating film opposite to the third region.

4. The method of claim 1, wherein the organic resin includes one of PI (Poly Imide), PET (Polyethylene Terephthalate), PEN (Poly Ethylene Napthalene), or PCT (Polycyclohexylenedimethylene Teraphthlate).

5. The method of claim 1, wherein the lamination step includes:
a first lamination step in which heat of a temperature within a range of 100° C. to 110° C. and a pressure within a range of 1 kgf/cm² to 3 kgf/cm² are applied to the upper insulating coating film and the lower insulating coating film; and
a second lamination step in which heat of a temperature in the range of 140° C. to 160° C. and a pressure in a range of 90 kgf/cm² to 110 kgf/cm² are applied to the upper insulating coating film and the lower insulating coating film.

6. The method of claim 5, wherein the lamination step further includes a third lamination step for compressing a reinforcing film onto a region of the lower insulating coating film opposite to the first region or the second region.

7. The method of claim 6, wherein the third lamination step occurs at a temperature within a range of 110° C. to 130° C. and a pressure within a range of 1 kgf/cm² to 3 kgf/cm².

8. The method of claim 1, wherein the coating film preparation step further includes:
an ultraviolet based pre-treatment step for irradiating ultraviolet rays to the upper insulating coating film and the lower insulating coating film; and
bonding a primer and an adhesive to each of the upper insulating coating film and the lower insulating coating film irradiated with the ultraviolet rays.

9. The method of claim 8, wherein the ultraviolet ray has a wavelength in a range of 170 nm to 180 nm.

10. The method of claim 1, wherein the method further comprises wrapping an outer face of the cut stack of the upper and lower insulating coating films with an insulating tube.

11. A flexible flat cable (FFC) for transmitting an electrical signal or electrical energy, the FFC comprising:
a film type main body extending in a length direction thereof and having both ends in the length direction; and
a terminal formed at each of the both ends of the film type main body,
wherein the film type main body includes:
upper and lower insulating coating layers made of an organic resin;
a plurality of conducting wires spaced apart from each other by a predetermined spacing and arranged in a width direction of the film type main body, wherein the plurality of conducting wires are disposed between the upper and lower insulating coating layers;
an adhesive filled into between the upper and lower insulating coating layers while surrounding the plurality of conducting wires to fix the plurality of conducting wires; and
an opening defined in a predefined region of the upper and/or lower insulating coating layers,
wherein predefined regions of the plurality of conducting wires are exposed to an outside through the opening,
wherein each of the plurality of conducting wires includes one of iron (Fe), sludge metal, and aluminum (Al).

12. The FFC of claim 11, wherein the film type main body is obtained using:
a first lamination process in which heat of a temperature within a range of 100° C. to 110° C. and a pressure within a range of 1 kgf/cm² to 3 kgf/cm² are applied to the insulating coating layers; and then
a second lamination process immediately after the first lamination process in which heat of a temperature within a range of 140° C. to 160° C. and a pressure within a range of 90 kgf/cm² to 110 kgf/cm² are applied to the insulating coating layers.

13. The FFC of claim 11, wherein the terminal further includes a reinforcing film connected to one of the upper and lower insulating coating layers,
wherein the reinforcing film is formed using a third lamination process in which a temperature in a range of 110° C. to 130° C. and a pressure in a range of 1 kgf/cm² to 3 kgf/cm² are applied to the reinforcing film and each of the insulating coating layers.

14. The FFC of claim 11, wherein each of the plurality of conducting wires has a thickness of 0.2 mm to 0.5 mm and a width of 0.05 mm to 0.15 mm.

15. The FFC of claim 11, wherein the organic resin includes one of PI (Poly Imide), PEN (Poly Ethylene Napthalene), or PCT (Polycyclohexylenedimethylene Teraphthlate).

16. The FFC of claim 11, wherein the adhesive includes polyester.

17. A stack-type busbar comprising a vertical stack of a first FFC (flexible flat cable) and a second FFC,
wherein each of the first FFC and the second FFC includes:
a film type main body extending in a length direction thereof and having both ends in the length direction; and
a terminal formed at each of the both ends of the film type main body,
wherein the film type main body includes:
upper and lower insulating coating layers made of an organic resin;
a plurality of conducting wires spaced apart from each other by a predetermined spacing and arranged in a width direction of the film type main body, wherein the plurality of conducting wires are disposed between the upper and lower insulating coating layers;
an adhesive filled into between the upper and lower insulating coating layers while surrounding the plurality of conducting wires to fix the plurality of conducting wires; and
an opening defined in a predefined region of the upper and/or lower insulating coating layers,
wherein predefined regions of the plurality of conducting wires are exposed to an outside through the opening,
wherein each of the plurality of conducting wires includes one of iron (Fe), sludge metal, and aluminum (Al),
wherein the opening of the first FFC and the opening of the second FFC are stacked one on top of another and are aligned with each other in a line parallel to a direction in which the first and second FFCs are stacked one on top of another.

18. The stack-type busbar of claim 17, wherein the busbar further comprises a connection terminal disposed at each of both longitudinal ends of the stack-type busbar, wherein the connection terminal is electrically connected to a first terminal of the first FFC and a second terminal of the second FFC, wherein the first and second terminals define the both longitudinal ends of the stack-type busbar, respectively.

19. The stack-type busbar of claim 17, wherein the stack-type busbar further comprises an insulating tube surrounding an outer surface of the stack-type busbar.

20. The stack-type busbar of claim 19, wherein the opening of the first FFC is positioned between two terminals of the first FFC, and the opening of the second FFC is positioned between two terminals of the second FFC.
